(19) United States
(12) Patent Application Publication
(10) Pub. No.: US 2026/0167557 A1
(43) Pub. Date: Jun. 18, 2026

(54) TITANIA-SILICA GLASS BODY WITH IDENTIFYING MARKER AND METHODS OF MAKING THEREOF

(71) Applicant: CORNING INCORPORATED, CORNING, NY (US)

(72) Inventors: Qiumei Bian, Painted Post, NY (US); Christopher Michael Cilip, Painted Post, NY (US); Jason Roy Grenier, Horseheads, NY (US); Ali Mohammadkhah, Painted Post, NY (US)

(21) Appl. No.: 19/416,449

(22) Filed: Dec. 11, 2025

Related U.S. Application Data
(60) Provisional application No. 63/735,052, filed on Dec. 17, 2024.

(51) Int. Cl. C03C 3/06; C03C 4/08

(52) U.S. Cl. CPC C03C 3/06; C03C 4/085

(57) ABSTRACT

A glass body with a top surface, an opposing bottom surface, and one or more side surfaces. An identifying marker is on the top surface, the bottom surface, the one or more side surfaces, and/or within a bulk of the glass body, the identifying marker providing encoded information about one or more properties, characteristics, and/or compositional features of the glass body, and wherein a composition of the glass body comprises titania and silica. Furthermore, a peak-to-valley of hydroxyl concentration among a plurality of segments of the glass body is about 60 ppm or less, the hydroxyl concentration being measured using a Fourier transform infrared spectroscopy in transmission, and the plurality of segments including every adjacent segment across a length and a width of the glass body, the length being about 25 mm or more and the width being about 25 mm or more.

This Application claims the benefit of priority to U.S. Provisional Patent Application Ser. No. 63/735052 filed on Dec. 17, 2024, the content of which is relied upon and incorporated herein by reference in its entirety.

### FIELD

The present disclosure is directed to titania-silica glass body with an identifying marker formed therein. The glass body comprises various properties, characteristics, and/or compositional features and the identifying marker provides encoding information about such properties, characteristics, and/or compositional features. The glass body may be suitable for use in extreme ultraviolet lithography applications.

### BACKGROUND

Extreme ultraviolet (EUV) lithography uses optics to illuminate, project, and reduce pattern images to form integrated circuit patterns. The use of extreme ultraviolet radiation is beneficial in that smaller integrated circuit features can be achieved. The optics for EUV lithography are currently made from low thermal expansion glass, such as silica-titania glass. The glass is traditionally made by a flame hydrolysis process in which high purity precursors are injected into flames to form fine glass particles that are then deposited onto a glass body.

In EUV lithography systems, the glass is typically coated with a reflective surface to form a reflective mirror or a photomask. Furthermore, the glass, in an EUV lithography system, must be able to meet stringent thermal expansion requirements in the system. Specifically, the glass must be able to maintain its surface shape (known as “figure”) when subject to temperature changes in the system. A temperature stable glass is necessary to avoid any induced distortions in the wavefront characteristics of EUV projection optics.

### SUMMARY

Embodiments of the present disclosure comprise methods to produce glass bodies that are able to advantageously maintain their figure during operation of an EUV lithography system. Therefore, the glass bodies, according to the embodiments of the present disclosure, reduce or prevent any distortions in the wavefront characteristics of EUV projection optics. Furthermore, the glass bodies disclosed herein comprise one or more identifying markers that provide encoding information about the bodies for use in, for example, an EUV lithography system.

According to aspects of the present disclosure, a glass body is disclosed that comprises a top surface, an opposing bottom surface, and one or more side surfaces. An identifying marker is on the top surface, the bottom surface, the one or more side surfaces, and/or within a bulk of the glass body, the identifying marker providing encoded information about one or more properties, characteristics, and/or compositional features of the glass body, wherein a composition of the glass body comprises titania and silica. Furthermore, a peak-to-valley of hydroxyl concentration among a plurality of segments of the glass body is about 60 ppm or less, the hydroxyl concentration being measured using a Fourier transform infrared spectroscopy in transmission, and the plurality of segments including every adjacent segment across a length and a width of the glass body, the length being about 25 mm or more and the width being about 25 mm or more.

According to aspects of the present disclosure, a glass body is disclosed that comprises a top surface, an opposing bottom surface, and one or more side surfaces. An identifying marker is on the top surface, the bottom surface, the one or more side surfaces, and/or within a bulk of the glass body, the identifying marker providing encoded information about at least one of refractive index, transmission, absorption, field of view, total thickness variation, bow, and warp of the glass body of the glass body, and wherein a composition of the glass body comprises silica.

According to aspects of the present disclosure, a method of producing a glass body with an identifying marker, the method comprising producing a glass body comprised of titania and silica, the glass body comprising a top surface, an opposing bottom surface, and one or more side surfaces. The method further comprising forming an identifying marker on the top surface, the bottom surface, the one or more side surfaces, and/or within a bulk of the glass body, the identifying marker providing encoded information about one or more properties, characteristics, and/or compositional features of the glass body, and wherein a peak-to-valley of hydroxyl concentration among a plurality of segments of the glass body is about 60 ppm or less, the hydroxyl concentration being measured using a Fourier transform infrared spectroscopy in transmission, and the plurality of segments including every adjacent segment across a length and a width of the glass body, the length being about 25 mm or more and the width being about 25 mm or more.

According to aspects of the present disclosure, a method of controlling access to encoded information of a glass body, the method comprising providing a glass body with an identifying marker, the identifying marker providing encoded information about one or more properties, characteristics, and/or compositional features of the glass body. The method further comprising managing user access to the encoded information, wherein a composition of the glass body comprises titania and silica. Furthermore, a peak-to-valley of hydroxyl concentration among a plurality of segments of the glass body being about 60 ppm or less, the hydroxyl concentration being measured using a Fourier transform infrared spectroscopy in transmission, and the plurality of segments including every adjacent segment across a length and a width of the glass body, the length being about 25 mm or more and the width being about 25 mm or more.

### BRIEF DESCRIPTION OF THE DRAWINGS

While the specification concludes with claims particularly pointing out and distinctly claiming the subject matter of the description, it is believed that the description will be better understood from the following specification when taken in conjunction with the accompanying drawings.

FIG. 1 is a flowchart of a process of forming a glass body with an identifying marker, according to embodiments disclosed herein;

FIG. 2 is a flowchart of a process of forming the glass body of FIG. 1, according to embodiments disclosed herein;

FIG. 3A is a schematic illustration of a system to produce loose soot particles in the process of FIG. 2, according to the embodiments disclosed herein;

FIGS. 3B and 3C each show molded bodies according to the process of FIG. 2, according to embodiments disclosed herein;

FIG. 4A shows an exemplary glass body, according to embodiments disclosed herein;

FIG. 4B shows another exemplary glass body with a sub-portion, according to embodiments disclosed herein;

FIG. 4C shows a cross-section of a sub-portion of the glass body of FIG. 4B, according to embodiments disclosed herein;

FIG. 4D shows another cross-section of a sub-portion of the glass body of FIG. 4B with an outer, peripheral lip, according to embodiments disclosed herein;

FIG. 4E shows an exemplary hydroxyl concentration plot of a sub-portion of the glass body of FIG. 4B divided into segments, according to embodiments disclosed herein;

FIG. 5A shows an exemplary glass body with an identifying marker, according to embodiments disclosed herein;

FIG. 5B shows another exemplary glass body with an identifying marker, according to embodiments disclosed herein;

FIG. 5C shows another exemplary glass body with multiple identifying markers, according to embodiments disclosed herein;

FIG. 6A shows a schematic of an exemplary identifying marker, according to embodiments disclosed herein;

FIG. 6B shows an exemplary identifying marker as a barcode, according to embodiments disclosed herein;

FIG. 6C shows an exemplary identifying marker as a data matrix, according to embodiments disclosed herein;

FIG. 7 shows a schematic of an exemplary marking system to prepare identifying marker on the glass body, according to embodiments disclosed herein;

FIG. 8 is a flowchart of a process of scanning the identifying marker on the glass body and obtaining decoded information of the identifying marker, according to embodiments disclosed herein; and

FIG. 9 is a schematic illustration of a system to produce a glass body, according to the embodiments disclosed herein;

### DETAILED DISCLOSURE

As used herein, “ppm” means parts per million by weight.

As used herein, “atm” means atmospheric pressure.

As used herein, the term “hydroxyl(s)” or OH means a moiety or a group of moieties each consisting of an oxygen atom and a protium atom (₁¹H, referred to herein as “H”), unless otherwise specified. As used herein, n(OH) means the total number of OH or hydroxyl moieties in a material.

As used herein, “protium” refers to the hydrogen isotope having a mass number of 1 and consisting of a single proton and electron. The symbols “H” and “H2” refer to protium (₁¹H) atoms and molecules, respectively, unless otherwise specified. As used herein, the terms n(H) and n(H₂) refer to the total number of protium atoms and molecules, respectively, in a material.

As used herein, “deuterium” refers to the hydrogen isotope having one proton and one neutron in its nucleus and having an atomic weight of 2.0144. The symbols “D” and “D₂” refer to deuterium (₁²H) atoms and molecules, respectively, unless otherwise specified. As used herein, the terms n(D) and n(D₂) refer to the total number of deuterium atoms and molecules, respectively, in a material.

As used herein, the term “deuteroxyl(s)” or OD means a moiety or a group of moieties, each consisting of an oxygen atom and a deuterium atom (₁²H or ₁²D, referred to herein as “D”). As used herein, n(OD) means the total number of OD moieties in a material. When hydroxyl and deuteroxyl groups are present in their natural isotopic abundance, the ratio of n(OD)/(n(OD) +n(OH)) in the material is equal to 2×l0⁻⁴.

As used herein, the terms “hydrogen” and “molecular hydrogen” refer to the naturally occurring mixture of protium and deuterium molecules and atoms (99.98% protium and 0.02% deuterium), unless otherwise stated.

Unless otherwise specified, when reference is made to any element other than hydrogen, it is understood that the element is present in its naturally occurring state; i.e., the isotopic distribution of the element is that which occurs in nature, and the element is not enriched in any one isotope.

As used herein, the term “fictive temperature” refers to a concept used to indicate the structural state of a glass. Glass that is cooled quickly from a high temperature typically exhibits a higher fictive temperature than an identical glass cooled from the same temperature more slowly because of the “frozen in” higher temperature structure. When a glass is held at an elevated temperature, the glass structure is allowed more time to relax toward the heat treatment temperature structure. Glasses with a relatively high fictive temperature have structures that are further removed from equilibrium than glasses with a relatively low fictive temperature.

EUV lithography technology relies on an optical projection system to expose a reflective mirror and/or photomask with EUV light, such that light reflected from the mirror and/or photomask is directed to a thin photosensitive layer deposited on the surface of a semiconductor wafer. This technique is commonly used in the semiconductor device production process. EUV lithography systems operate at a wavelength of light of about 13.5 nm. This extremely short wavelength poses a number of challenges to the design of the EUV systems. For example, reflective coatings on the bodies of the mirror and/or photomask in EUV systems are not able to reflect all of the light with such a low wavelength. About thirty percent of the light is absorbed by the reflective coatings, rather than reflected. The absorbed light produces undesirable heat in the glass body, causing the glass body to change shape (e.g., thermally expand or contract). Such changes in the glass body can in turn cause the reflective coating on the glass body to deform, which leads to distortions in the wavefront of the reflected light. Wavefront distortions may lead to deterioration in the resolution of the EUV system and errors in the patterns formed on the photosensitive layer.

Thus, the glass bodies of the mirror and/or photomask must be able to maintain their shape and figure even when subjected to the demanding thermal loads of EUV systems. Silica-titania glass, such as ULE® Glass, is presently the material of choice for glass bodies in EUV systems.

It has recently been shown that higher levels of compositional uniformity in silica-titania glass minimize any change of shape of the glass in an EUV system. More specifically, with such higher levels of uniformity, the glass maintains its overall figure when subject to temperature changes in the EUV system. Embodiments of the present disclosure are directed to producing glass bodies with such compositional uniformity. In particular, embodiments of the present disclosure are directed to producing glass bodies with uniform concentrations of OH (and OD).

Furthermore, it is desirable for a user to readily have access to the composition and properties of the produced glass body. Such may help determine the functionality of the glass in, for example, an EUV system. Therefore, embodiments of the present disclosure are also directed to producing such glass bodies with identifying markers formed therein, such that the identifying markers provide compositional and property information of the produced glass bodies.

Furthermore, embodiments of the present disclosure are directed to producing glass bodies with either low or high concentrations of OH (and OD). With relatively lower concentrations of OH (and OD), it is easier to produce the desired compositional uniformity in the glass than with relatively higher concentrations of OH (and OD). More specifically, with relatively low concentrations, any offset from a mean OH (or OD) concentration is still within an acceptable range to achieve the required composition uniformity. Because the OH (and OD) concentrations are so low, any offset from the mean OH (or OD) is also quite low. However, with larger concentrations, the offset from the mean concentration can become quite large, thus producing OH (and OD) concentrations that vary widely across the glass body. Because the OH (and OD) concentrations are so high, the offset from the mean can also be quite high.

It is also known in the art that glass bodies with relatively lower OH (and OD) concentrations tend to have higher viscosity, which allows the glass to achieve a higher fictive temperature when annealed. A higher fictive temperature advantageously correlates to a lower coefficient of thermal expansion (CTE) value. As is known in the art, CTE is a material property of the glass that is indicative of the extent to which the material expands (changes shape) when heated. Therefore, lower CTE values advantageously allows the glass body to not change shape when exposed to different temperature environments, which as discussed above, is beneficial in lithography applications.

The compositional uniformity of the glass bodies (e.g., OH and OD uniformity) is ultimately desired in order to achieve uniform and low CTE of the glass. Uniform and low CTE values advantageously allow the shape of the glass body to remain substantially constant when the glass is heated, which is necessary in EUV systems. As discussed above, undesirable heat or non-uniform heat in an EUV system can cause a glass body in the system to thermally expand or contract. But a glass body with a uniform and low CTE value would not be as susceptible to such expansion or contraction distortions when heated.

Modifiers may be added to glass bodies to improve the expansivity behavior of the glass. However, it is known in the art that such modifiers decrease the homogeneity of the glass, making it more difficult to create a homogenous glass. A homogenous glass is important not only with regard to the thermal expansion behaviors of the glass but also with regard to its polishing capabilities. For example, the uniformity of the TiO₂ concentration throughout a glass body affects the polishing capabilities of that glass body. In particular, a glass body with different localized areas of TiO₂ concentration would polish unevenly, as areas with different concentrations of TiO₂ in a glass polish at different rates. Therefore, embodiments of the present disclosure also produce glass bodies with uniform concentrations of TiO₂ so that the glass will polish evenly.

Another important feature for glass bodies in EUV systems is the temperature at which the CTE of the glass body is exactly equal to zero. This temperature is known as the zero crossing temperature and is denoted Tzc. Glass bodies in EUV systems should ideally have a Tzc value near the temperature of the glass body when it is exposed to the EUV light of the EUV system. When the Tzc value matches (or is close to) this temperature, the glass body will experience minimal expansion (and, thus, minimal figure distortion) during operation of the EUV system.

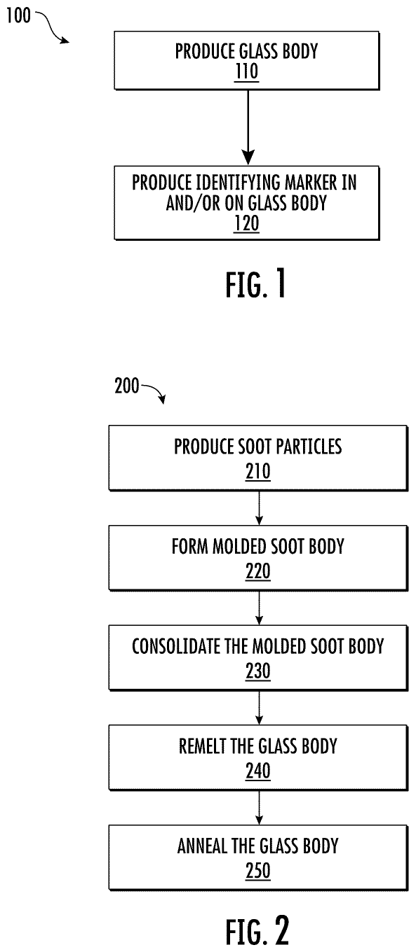

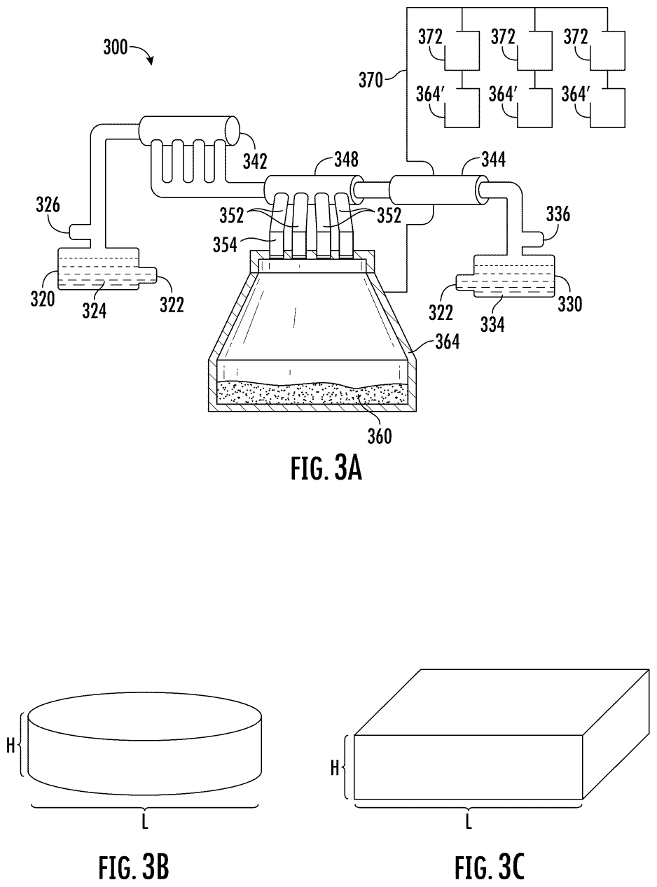

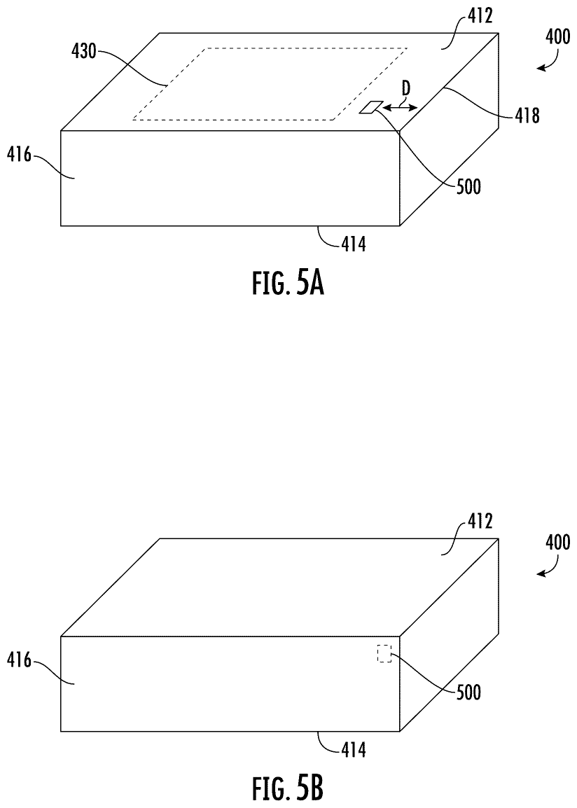

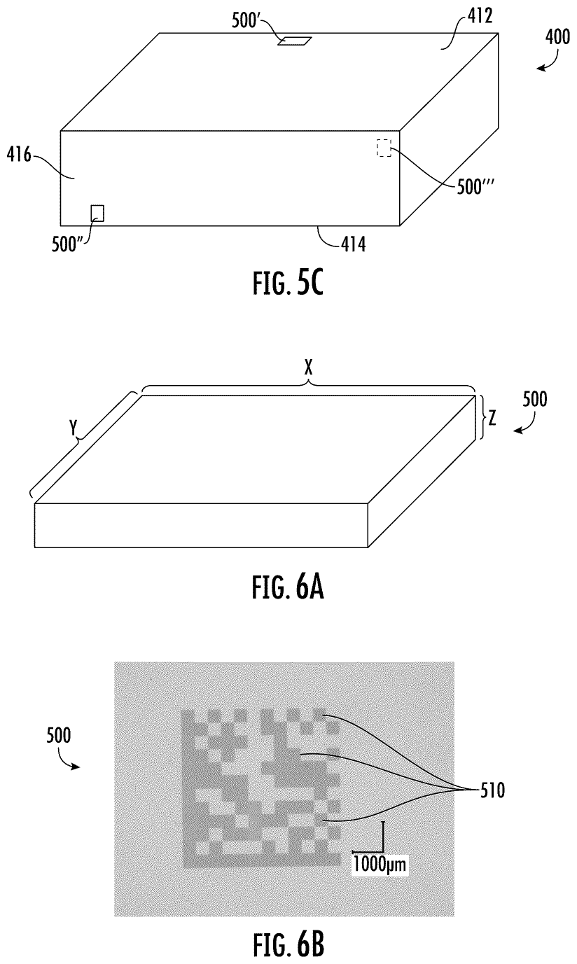

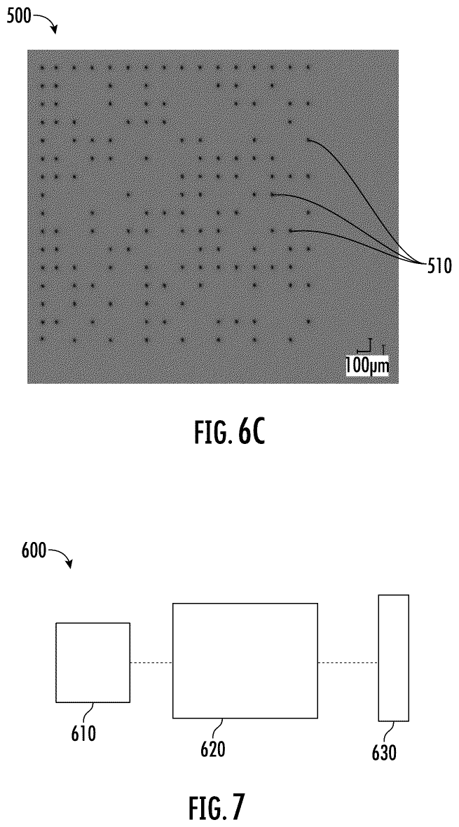

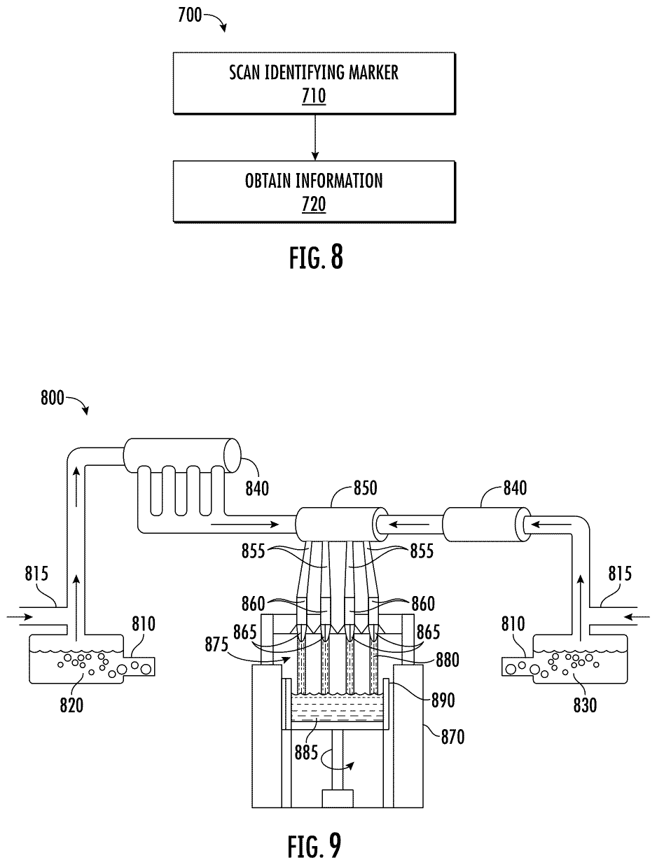

With reference to FIG. 1, a process 100 of producing a glass body and marking the glass body with an identifier is disclosed. In particular, step 110 of process 100 comprises producing a glass body. As discussed further below, the produced glass body comprises various properties, characteristics, and/or compositional features. As discussed further below, the process by which glass body is produced may dictate and control the various properties, characteristics, and/or compositional features of the produced glass body. Process 100 further comprises, at step 120, producing an identifying marker in and/or on the glass body. The identifying marker may comprise information about the produced glass body including encoding information about the various properties, characteristics, and/or compositional features of the glass body. In embodiments, the identifying marker may comprise a barcode, a QR code, a dot code, a data matrix, one or more encrypted features, and/or an object identifier. In some embodiments, the produced glass body is a photomask or a reflective mirror and the identifying marker in the glass body provides an indication of the suitability of the glass body for its use as a photomask or reflective mirror. In yet some other embodiments, the produced glass body is a lightguide and the identifying marker in the glass body provides an indication of the suitability of the glass body for its use in an augmented reality device. Step 110 of producing the glass body is described in more detail with reference to process 200 of FIG. 2 and system 300 of FIG. 3A in some embodiments. In yet other embodiments, step 110 of producing the glass body is described in more detail with reference to system 800 of FIG. 8. Furthermore, the identifying markers disclosed herein are shown in greater detail with reference to FIGS. 5A-6C.

Process 200, as shown in FIG. 2, comprises steps to produce a glass body according to the embodiments disclosed herein. Step 210 of process 200 comprises the production of soot particles. In the latter steps of process 200, the soot particles are then formed into a molded soot body and consolidated, remelted and/or annealed to form the produced glass body. But, with reference to step 210, the soot particles may be formed as loose soot particles and then collected in one or more chambers.

FIG. 3A depicts a schematic representation of a system 300 to produce the loose soot particles of step 210 of process 200 using a combustion process. As shown in FIG. 3A, system 300 comprises a first reservoir 320 that houses a silica precursor 324 and a second reservoir 330 that houses a titania precursor 334. First reservoir 320 includes an inlet 322 for introduction of a carrier gas, such as nitrogen, at or near the base of the reservoir. The carrier gas forms a vaporous stream with the silica precursor 324. Similarly, second reservoir 330 includes an inlet 332 for introduction of a carrier gas, such as nitrogen, at or near the base of the reservoir. The carrier gas in second reservoir 330 forms a vaporous stream with the titania precursor 334.

The silica precursor 324 may comprise, for example, SiCl₄ and/or octamethylcyclotetrasiloxane (OMCTS). The titania precursor 334 may comprise, for example, TiCl₄ or titanium isopropoxide (TPT) (titanium tetraisopropoxide (TTIP), tetraisopropyltitanate (TIPT)).

Bypass streams of carrier gas are also introduced into system 300 at inlets 326 and 336 to prevent saturation of the vaporous silica stream and the vaporous titania stream. The vaporous silica stream then passes through distribution system 342 to manifold 348, and the vaporous titania stream passes through distribution system 344 to manifold 348.

The silica and titania vaporous streams then mix in manifold 348 to form a mixture of the two streams. As further shown in FIG. 3A, the mixture of the two streams flows to reaction chamber 364. More specifically, the mixture of the two streams passes through fume lines 352 to burners 354 mounted in an upper portion of reaction chamber 364. The two streams are further joined with a fuel/oxygen mixture at burners 354 to combust and oxidize the mixture. The fuel may be natural gas. The oxidation and combustion of the mixture forms loose soot particles 360, which are cooled and directed into reaction chamber 364. Soot particles 360 comprise silicon dioxide and titanium dioxide. More specifically, the silicon dioxide and titanium dioxide in the particles mix at the atomic level to form Si—O—Ti bonds.

In some embodiments, soot particles 360 are directed upward through a tube 370 rather than downward into collection chamber 364. Tube 370 may be a quartz tube, which carries soot particles 360 in a vaporous stream to one or more filter bags 372. The soot particles 360 are removed from the vaporous stream by the filter bags 372 and are then deposited into one or more collection chambers 364′. For example, the soot particles 360 fall downward from filter bags 372 and into collection chambers 364′. A pulse of N₂ may periodically be applied to filter bags 372 to prevent the excess accumulation of soot particles 360 on the bags. In some embodiments, collection chambers 364′ are stainless steel hoppers. The soot particles 360 can then be further collected from collection chambers 364′ and deposited into barrels, where soot particles 260 may be stored until further use.

The produced soot particles 360 are spherical in shape with substantially uniform distributions of SiO₂ and TiO₂ within the particles. The size of each soot particle 360 may vary depending on the conditions of burners 354, but in general, soot particles 360 have an average diameter of about 20 nm to about 500 nm, or about 50 nm to about 400 nm, or about 60 nm to about 300 nm, or about 50 nm to about 100 nm.

Soot particles 360 may cool to about 200° C. or less, or about 175° C. or less, or about 150° C. or less, or about 125° C. or less, or about 100° C. or less, or about 75° C. or less, or about 50° C. or less, or about 25° C. or less, or about 20° C. or less before reaching collection chambers 364, 364′.

With reference again to FIG. 2, at step 220 of process 200, soot particles 360 are removed from reaction chamber 364 and/or collection chambers 364′ and deposited into a mold to form a pressed and molded soot body. The mold may comprise a pressing apparatus to press the soot particles into the pressed and molded soot body, which has a density of about 0.50 g/cm³ or greater, or about 0.55 g/cm³ or greater, or about 0.60 g/cm³ or greater, or about 0.65 g/cm³ or greater, or about 0.70 g/cm³ or greater, or about 0.75 g/cm³ or greater, or about 0.80 g/cm³ or greater, or about 0.85 g/cm³ or greater. Additionally or alternatively, the molded soot body has a density of about 1.50 g/cm³ or less, or about 1.40 g/cm³ or less, or about 1.30 g/cm³ or less, or about 1.20 g/cm³ or less, or about 1.15 g/cm³ or less, or about 1.10 g/cm³ or less, or about 1.00 g/cm³ or less, or about 0.95 g/cm³ or less, or about 0.90 g/cm³ or less, or about 0.85 g/cm³ or less, or about 0.80 g/cm³ or less, or about 0.75 g/cm³ or less, or about 0.70 g/cm³ or less. In embodiments, the molded soot body has a density from about 0.50 g/cm³ to about 1.50 g/cm³, or about 0.60 g/cm³ to about 1.40 g/cm³, or about 0.80 g/cm³ to about 1.30 g/cm³, or about 0.90 g/cm³ to about 1.00 g/cm³, or about 0.80 g/cm³ to about 1.50 g/cm³, or about 0.80 g/cm³ to about 1.20 g/cm³, or about 0.80 g/cm³ to about 0.90 g/cm³. The molded soot body is formed such that any density variation in the body is about 5% or less, or about 4% or less, or about 3% or less, or about 2% or less, or about 1% or less, or about 0.75% or less, or about 0.50% or less, or about 0.25% or less, or about 0.20% or less, or about 0.15% or less, or about 0.10% or less, or about 0.05% or less, or about 0.02% or less, or about 0.01% or less, or about 0.00% from an average density across the body. FIG. 3B shows an exemplary cylindrical molded soot body and FIG. 3C shows an exemplary rectangular molded soot body, although the molded soot body may comprise other shapes than those specifically depicted herein. As shown in FIGS. 3B and 3C, the molded soot body has a length L and a height H. It is noted that the length L is also the diameter for the cylindrical body of FIG. 3B.

In embodiments, the length L of the body may be from about 20 mm to about 1300 mm, or about 40 mm to about 1200 mm, or about 60 mm to about 1000 mm, or about 80 mm to about 800 mm, or about 100 mm to about 60 mm, or about 20 mm to about 40 mm. Furthermore, in some embodiments, the height H of the body is about 50 m to about 500 mm, or about 60 mm to about 400 mm, or about 80 mm to about 200 mm, or about 100 mm to about 200 mm, or about 250 mm to about 500 mm, or about 250 mm to about 400 mm, or about 250 mm to about 300 mm, or about 200 mm to about 500 mm, or about 200 mm to about 400 mm, or about 200 mm to about 300 mm. However, it is noted that the length L and height H of the body can vary and are not limited by the embodiments disclosed herein. It is also noted that in some embodiments, the length L is larger than the height H of the body, while in other embodiments the height H is larger than the length L.

With reference again to process 200, at step 230, the molded soot body is then consolidated into a glass body, as discussed further below. After consolidation, the body is remelted at step 240 and then annealed at step 250 to relax any internal stress in the body and lower the Tf in the body, along with lowering Tf variations in the body. Relaxed internal stress allows for better quality cutting and machining of the body, such as slicing the body into a plurality of slices. In some embodiments, the body is annealed for a duration of about 100 hours or more, or about 200 hours or more, or about 250 hours or more. The maximum annealing temperature may be from about 750° C. to about 1200° C., or about 800° C. to about 1100° C., or about 900° C. to about 1000° C. Once the annealing step is complete, the body may be subjected to subsequent finishing steps such as shaping, grinding, polishing, and/or slicing.

During the consolidation of step 230, the molded soot body is heated in a furnace. In some embodiments, the molded soot body is first heated to a first temperature T1 between about 800° C. and about 1100° C., or about 825° C. and about 1075° C., or about 850° C. and about 1050° C., or about 875° C. and about 1025° C., or about 900° C. and about 1000° C., or about 925° C. and about 975° C., or about 950° C. and about 1000° C. The body may be held at the first temperature T1 such that the first temperature T1 is constant during the entirety of the first thermal treatment, with any temperature varying only by about 5° C. or less, or about 4° C. or less, or about 3° C. or less, or about 2° C. or less, or about 1° C. or less, or about 0.5° C. or less from an average temperature during the first thermal treatment. Due to such constant temperature, the heating of the body at the first temperature T1 may also be referred to as an isothermal hold.

In embodiments, the first time duration during which the molded soot body is heated to the first temperature T1 is from about 30 minutes to about 35 hours, or about 1 hour to about 30 hours, or about 1.5 hours to about 27 hours, or about 2 hours to about 25 hours, or about 4 hours to about 22 hours, or about 6 hours to about 20 hours, or about 8 hours to about 18 hours, or about 10 hours to about 15 hours, or about 12 hours to about 16 hours, or about 30 minutes to about 10 hours, or about 1 hour to about 8 hours, or about 15 hours to about 30 hours. In some exemplary embodiments, these time durations are for a body with a length L of 0.25 m and a height H of 0.25 m.

Heating of the body at the first temperature T1 may be in an inert environment in the presence of an inert gas. By “inert gas,” it is meant a gas that does not chemically react with the body. In some embodiments, as discussed further below, the body may be exposed to a steam doping process while heating the body at the first temperature T1.

While not wishing to be bound by theory, it is believed that heating the body at the temperature first T1, as disclosed herein, advantageously produces uniform pressure and temperature in the body by enabling purging and removal of gases from the body, which ultimately helps to achieve the uniform hydroxyl concentrations disclosed below.

The consolidation of step 230 of process 200 further comprises a ramp-up step during which the temperature increases from the first temperature T1 to a second temperature T2. The increase in temperature from first temperature T1 to second temperature T2, during the ramp-up step, may be at a rate of about 20° C./hour or greater, or about 25° C./hour or greater, or about 30° C./hour or greater, or about 35° C./hour or greater, or about 40° C./hour or greater, or about 45° C./hour or greater, or about 50° C./hour or greater, or about 55° C./hour or greater, or about 60° C./hour or greater, or about 65° C./hour or greater, or about 70° C./hour or greater, or about 75° C./hour or greater, or about 80° C./hour or greater. In some embodiments, the increase in temperature from first temperature T1 to second temperature T2, during the ramp-up step, may be at a rate from about 20° C./hour to about 120° C./hour, or about 30° C./hour to about 100° C./hour, or about 40° C./hour to about 80° C./hour, or about 50° C./hour to about 100° C./hour, or about 50° C./hour to about 80° C./hour. A total time duration of the ramp-up step may be from about 0.5 hours to 18 hours, or about 1 hour to about 16 hours, or about 1.5 hours to about 14 hours, or about 2 hours to about 12 hours, or about 2.5 hours to about 12 hours, or about 3 hours to about 10 hours, or about 4.5 hours to about 8 hours, or about 5 hours to about 6 hours.

The consolidation of step 230 of process 200 further comprises heating the molded soot body at the second temperature T2, which is between about 1050° C. and about 1250° C., or about 1100° C. and about 1200° C., or about 1125° C. and about 1200° C., or about 1150° C. and about 1200° C., or about 1100° C. and about 1150° C., or about 1125° C. and about 1175° C., or about 1125° C. and 1150° C. The body may be held at the second temperature T2 such that the second temperature T2 is constant during the entirety of the second thermal treatment, with any temperature varying only by about 5° C. or less, or about 4° C. or less, or about 3° C. or less, or about 2° C. or less, or about 1° C. or less, or about 0.5° C. or less from an average temperature during the second thermal treatment. Due to such constant temperature, the heating of the body at the second temperature T2 may also be referred to as an isothermal hold.

The body may be held at the second temperature T2 for a second time duration t2 of about 6 hours or greater, or about 10 hours or greater, or about 1 day or greater, or about 2 days or greater, or about 3 days or greater, or about 4 days or greater, or about 5 days or greater, or about 6 days or greater, or about 7 days or greater, or about 8 days or greater, or about 9 days or greater, or about 10 days or greater. In some embodiments, the maximum time duration may be about 20 days or less, or about 18 days or less, or about 16 days or less, or about 14 days or less, or about 12 days or less, or about 10 days or less, or about 8 days or less, or about 6 days or less, or about 4 days or less, or about 2 days or less, or about 1 day or less.

While not wishing to be bound by theory, it is believed that the majority of the glass sintering to fully consolidate the body is performed during the heating of the body at the second temperature T2.

The consolidation process steps disclosed herein (e.g., the heating of the glass body at the first temperature T1, the heating of the glass body at the second temperature T2, and/or the ramp-up step) may be conducted under vacuum pressure wherein the body is not actively doped with hydroxyl. These embodiments may be referred to as “no OH doping” because the thermal treatment steps and/or ramp-up step are conducted in an atmosphere that is free (or essentially free) of water and steam. In contrast, in other embodiments, the consolidation process steps disclosed herein (e.g., the heating of the glass body at the first temperature T1, the heating of the glass body at the second temperature T2, and/or the ramp-up step) may be conducted in the presence of steam, which is also referred to herein as steam doping. As discussed further below, the body is doped with hydroxyl during the steam doping such that the resultant glass body has a relatively higher concentration of hydroxyl. Conversely, the “no OH doping” process produces a glass body with a relatively lower concentration of hydroxyl.

In yet other embodiments, the body may be actively dried during the consolidation process steps disclosed herein (e.g., the heating of the glass body at the first temperature T1, the heating of the glass body at the second temperature T2, and/or the ramp-up step). During such active drying embodiments, the body is exposed to a drying agent while heating the body. In embodiments, the drying agent may be a halide, such as chloring and/or fluorine, or carbon monoxide. Actively drying the body during the consolidation steps produces a glass body with a reduced concentration of hydroxyl, even less when compared with the “no OH doping” process.

It is further noted that in the “no OH doping” and steam doping processes, the body may not be exposed to a halide agent. Therefore, in these embodiments, the final glass body may not comprise a halide such that the produced glass body is halide-free (may comprise less than 100 ppm of a halide or even 0.00 ppm of a halide).

As discussed above, the body may be exposed to a steam doping process during the consolidation process steps disclosed herein (e.g., the heating of the glass body at the first temperature T1, the heating of the glass body at the second temperature T2, and/or the ramp-up step) so that the body is consolidated in the presence of steam. Such increases the hydroxyl concentration in the resultant glass body. The steam doping process comprises exposing the body to a steam-containing atmosphere within the consolidation furnace to load the body with hydroxyl groups. The steam-containing atmosphere may include only steam or steam in combination with an inert gas. The partial pressure of the steam may be about 1.0 atm or less, or about 0.50 atm or less, or about 0.40 atm or less, or about 0.30 atm or less, or about 0.20 atm or less, or about 0.10 atm or less, or about 0.05 atm or less. In embodiments, the partial pressure of the steam is greater than about 0.00 atm, or about 0.01 atm or greater, or about 0.05 atm or greater, or about 0.08 atm or greater, or about 1.0 atm or higher, or greater than about 0.00 atm to about 1.0 atm, or about 0.05 atm to about 1.0 atm, or about 0.25 atm to about 0.8 atm, or about 0.50 atm to about 0.75 atm, or greater than about 0.00 atm to about 0.25 atm, or greater than about 0.00 atm to about 0.20 atm. It is noted that in embodiments in which the body is exposed to the “no OH doping” process (as opposed to the steam doping process), the partial pressure of steam within the consolidation furnace is at 0.0 atm (it is noted that 0.0 atm may only be achieved in theory while, in practice, a partial pressure of about 0.02 atm or less may be achieved for the “no OH doping” process due to practical limitations). During the steam doping process, the steam partial pressure should be constant within the consolidation furnace with any pressure difference being only +/−2% of the absolute pressure in the furnace. It is also noted that longer steam doping exposure times lead to higher concentrations of hydroxyl in the body.

In some embodiments, the body is exposed to an environment comprised of steam during the heating of the glass body at the first temperature T1, the heating of the glass body at the second temperature T2, and the ramp-up step. In other embodiments, the body is exposed to an environment comprised of steam during the heating of the glass body at the second temperature T2 (but not during the heating of the glass body at the first temperature T1 and not during the ramp-up step).

The use of steam in the above-disclosed steam doping processes offers many benefits including the benefit of high hydroxyl concentrations in the glass, which reduces viscosity, promotes low fictive temperature, and avoids seed formation in the glass.

Additional embodiments of the above-disclosed steam doping process are disclosed in U.S. Pat. No. 9,580,350, which is incorporated by reference in its entirety.

With the completion of the consolidation of step 230, the molded body is now converted to consolidated glass, which is then remelted (step 240) and annealed (step 250), in the embodiments disclosed herein.

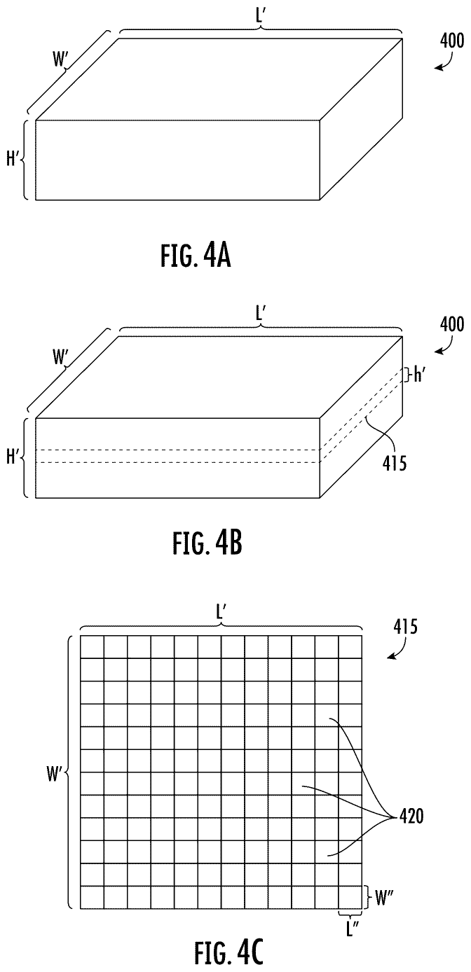

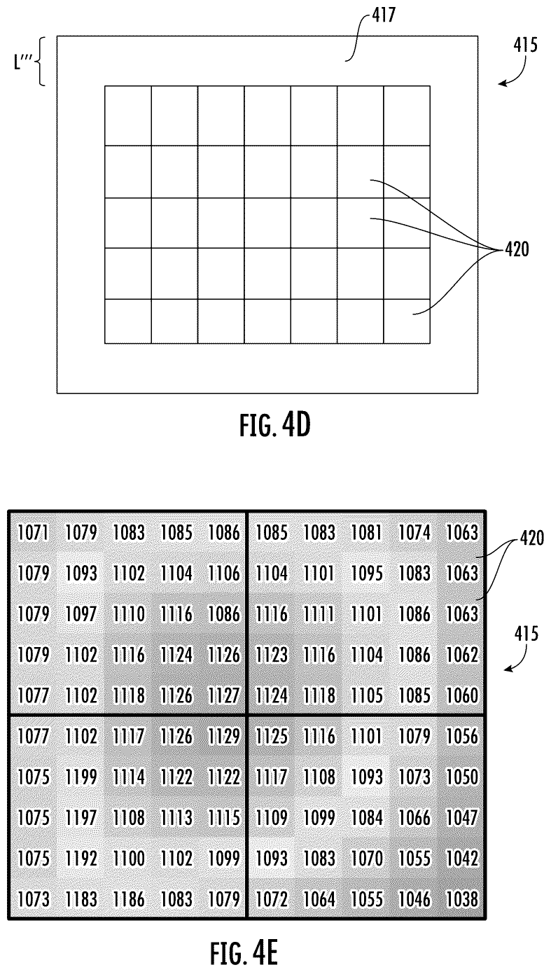

After the annealing of step 250 of process 200, a glass body is produced. FIG. 4A shows an exemplary glass body 400 produced using the processes disclosed herein. Glass body 400 may be an ingot or a substrate to which one or more layers may be applied in downstream processing. Furthermore, glass body 40 may be a sliced or un-sliced body. And glass body 400 may be flat, substantially flat, concave, or convex in structure.

As discussed further below, glass body 400 may comprise various properties, characteristics, and compositional features, which may be documented by or linked to one or more identifying markers in glass body 400. FIG. 5A shows an exemplary identifying marker 500 in glass body 400. For example, the identifying marker 500 may be a code or encryption documenting and/or encoding the various properties, characteristics, and/or compositional features of glass body 400. As discussed further below, identifying marker 500 may be three-dimensional. It is noted that each glass body produced using the processes disclosed herein may comprise slightly different properties, characteristics, and/or compositional features. Thus, identifying marker 500 may document and link a specific glass body with its specific properties, characteristics, and/or compositional features.

Such properties, characteristics, and/or compositional features may include, but are not limited to the composition of the glass body including the concentration of silica, titania, and/or hydroxyl in the glass body, the compositional variation of various components in the glass body such as the peak-to-valley concentration of hydroxyl and/or titania in the glass body, the refractive index of the glass body including the peak-to-valley variation of the refractive index, the CTE of the glass body, the Tzc of the glass body, the total thickness variation along the glass body, the flatness of the glass body, the dimensions of the glass body including its length, width, and height, the weight and/or density of the glass body, the transmittance and absorption of the glass body, and/or the field of view of the glass body.

In embodiments, the properties, characteristics, and/or compositional features of glass body 400 may comprise the silica and/or titania concentration of the glass body. The silica concentration of glass body 400 may be about 80 wt. % or more, or about 85 wt. % or more, or about 90 wt. % or more, or about 92 wt. % or more, or about 95 wt. % or more, or about 97 wt. % or more, or about 98 wt. % or more, or about 99 wt. % or more, or from about 85 wt. % to about 97 wt. %, or from about 90 wt. % to about 95 wt. %, or any range encompassing these endpoints. The titania concentration of glass body 400 may be from about 1.0 wt. % to about 15.0 wt. %, or from about 6.0 wt. % to about 12.0 wt. %, or from about 6.0 wt. % to about 8.5 wt. %, or from about 6.5 wt. % to about 8.0 wt. %, or from about 7.0 wt. % to about 7.7 wt. %, or from about 6.5 wt. % to about 7.8 wt. %, or any range encompassing these endpoints. In embodiments, the properties, characteristics, and/or compositional features of glass body 400 may include the concentration ranges of one or more components and/or the relative amount of the various components.

In embodiments, the properties, characteristics, and/or compositional features of glass body 400 may comprise the length, width, and/or height H of the glass body. As shown in FIG. 4A, glass body 400 comprises a length L′, a width W′, and a height H′. In some embodiments, each of the length L′ and the width W is greater than the height H′. For example, the length L′ and the width W′ may each be about 500 mm or less, or about 450 mm or less, or about 400 mm or less, or about 350 mm or less, or about 300 mm or less, or about 250 mm or less, or about 200 mm or less, or about 150 mm or less, or about 100 mm or less, or about 75 mm or less, or about 50 mm or less, or about 25 mm or less, or about 20 mm or less, or about 15 mm or less. Additionally or alternatively the length L′ and width W′ of glass body 400 are each about 15 mm or greater, or about 20 mm or greater, or about 25 mm or greater, or about 50 mm or greater, or about 75 mm or greater, or about 100 mm or greater, or about 150 mm or greater, or about 200 mm or greater, or about 250 mm or greater, or about 300 mm or greater, or about 350 mm or greater, or about 400 mm or greater, or about 450 mm or greater, or about 500 mm or greater. In some embodiments, both the length L′ and the width W′ are about 150 mm, or about 152 mm, or about 179 mm. However, it is also contemplated that the length L′ can be different from the width in some embodiments.

Furthermore, the height H′ may be smaller than each of the length L′ and the width W′. In some embodiments, the height H′ is about 400 mm or less, or about 350 mm or less, or about 300 mm or less, or about 250 mm or less, or about 200 mm or less, or about 150 mm or less, or about 100 mm or less, or about 75 mm or less, or about 50 mm or less, or about 25 mm or less, or about 20 mm or less, or about 15 mm or less, or about 10 mm or less, or about 5 mm or less. Additionally or alternatively, the height H′ is about 5 mm or greater, or about 10 mm or greater, or about 15 mm or greater, or about 20 mm or greater, or about 25 mm or greater, or about 50 mm or greater, or about 75 mm or greater, or about 100 mm or greater, or about 150 mm or greater, or about 200 mm or greater, or about 250 mm or greater, or about 300 mm or greater, or about 350 mm or greater, or about 400 mm or greater. In some embodiments, the height H′ is about 63 mm, or about 150 mm, or about 152 mm.

In embodiments, the properties, characteristics, and/or compositional features of glass body 400 may include the length, width, and height ranges of glass body 400 and/or the length, width, and/or height of glass body 400 relative to each other.

Although FIG. 4A depicts glass body 400 as being square components with flat surfaces, it is also contemplated in embodiments that glass body 400 comprises other shapes. For example, the outer profile of glass body 400 can be circular or elliptical or a non-symmetrical shape. Furthermore, glass body 400 can be curved forming a concave or convex structure. In embodiments, the properties, characteristics, and/or compositional features of glass body 400 may comprise the outer profile and shape of glass body 400 and/or the curvature of glass body 400.

In embodiments, the properties, characteristics, and/or compositional features of glass body 400 may comprise the uniformity of the compositional components of glass body 400. For example, the hydroxyl uniformity along glass body 400 or along a portion of glass body 400. The uniformity of such compositional components is determined by dividing the body into a plurality of sub-portions 415, as shown in FIG. 4B. In the embodiment of FIG. 4B, each sub-portion 415 comprises the length L′ and width W′ of glass body 400. However, the height h′ of each sub-portion 415 is less than the height H′ of glass body 400. Thus, in this embodiment, glass body 400 comprises multiple sub-portions 415 along its height H′. However, it is also contemplated in other embodiments, that one sub-portion 415 extends along the entire height H′ of glass body 400 (such that the one sub-portion 415 forms the entire glass body 400).

In order to determine the uniformity of sub-portions 415 in glass body 400, each sub-portion 415 is divided into segments across the length and width of the sub-portion. For example, FIG. 4C shows sub-portion 415 divided into segments 420 across the cross-sectional length L′ and width W′ of sub-portion 415. The concentration of one or more components (e.g., hydroxyl, titania) may be then determined for each segment 420 in order to determine the uniformity of each of these components along sub-portion 415. For example, the concentration of hydroxyl may be measured for each segment 420 in order to determine the hydroxyl concentration uniformity across the cross-section of sub-portion 415. As discussed further below, the concentration of the one or more components is determined through the full thickness h′ of each sub-portion 415.

Although FIG. 4C shows segments 420 as extending along the entire length L′ and width W′ of sub-portion 415, it is also contemplated that the portion of sub-portion 415 that comprises segments 420 may be less than the entire cross-sectional length L′ and width W′. For example, as shown in FIG. 4D, sub-portion 415 may comprise an outer, peripheral lip 417 upon which segments 420 are not formed. Therefore, outer, peripheral lip 147 may be a clearance between the end of segments 420 and the outer edge of sub-portion 415. In embodiments, the outer, peripheral lip 417 may extend for a length L″′ from about 2 mm to about 20 mm, or about 4 mm to about 16 mm, or about 5 mm to about 16 mm, or about 8 mm to about 14 mm, or about 10 mm to about 12 mm. In some embodiments, the length L″′ is about 12.5 mm or about 12.7 mm.

Segments 420 may be adjacent segments across a specific length and width of sub-portion 415 (such that no gaps are formed between the adjacent segments). As discussed above, this specific length and width (across which the measured segments 420 extend) may be equal to or less than the length L′ and width W′ of sub-portion 415. In embodiments, segments 420 are adjacent segments across a length and width (across which all the measured segments 420 extend) of sub-portion 415 such that the length and width are each about 25 mm or greater, or about 30 mm or greater, or about 40 mm or greater or about 50 mm or greater, or about 60 mm or greater, or about 75 mm or greater, or about 100 mm or greater, or about 125 mm or greater, or about 150 mm or greater, or about 175 mm or greater, or about 180 mm or greater, or about 190 mm or greater, or about 200 mm or greater, or about 250 mm or greater.

When sub-portion 415 comprises a flat surface, segments 420 are formed along the flat planar surface, as shown in FIG. 4C. However, when sub-portion 415 comprises a concave or convex surface, segments 420 are formed along the curving surface of sub-portion 415.

As shown in FIG. 4C, each segment 420 has a length L″ and a width W″ that are each about 12.7 mm, in embodiments. However, it is also contemplated in other embodiments that the length L″ is not equal to the width W″. It is also noted that in some embodiments, the length L″ and the width W″ of segments 420 may be equal to the length L″′ of peripheral lip 417.

The height of each segment 420 is the height h′ of sub-portion 415, as discussed above. Therefore, in embodiments, the height h′ is about 7.62 mm.

As discussed above, the concentration of one or more components may be determined within each segment 420. Therefore, for example, the concentration of hydroxyl may be determined for each adjacent segment 420 within sub-portion 415. When each segment 420 has a length and width of 12.7 mm, the concentration of the components is determined at a frequency of 12.7 mm across the cross-section of sub-portion 415. For example, the concentration of hydroxyl is measured at a frequency of 12.7 mm across the cross-section of sub-portion 415.

The concentration of hydroxyl for each segment 420 is measured using Fourier transform infrared spectroscopy (“FTIR”) in transmission. As used herein, “in transmission” means that the light is directed through the glass body to be measured to determine the hydroxyl concentration (rather than using light that is reflected from the body to be measured to determine the hydroxyl concentration). Therefore, “in transmission” requires a non-scattering surface. Once sub-portion 415 is loaded into the FTIR for measurement, a beam alignment and background measurement may be performed first. Then the FTIR measures the fundamental absorption peak for hydroxyl, which measures the peak height with respect to the background signal, the background signal being a straight line between the points surrounding the absorption peak. The absorption peak height is then divided by the thickness h′ of sub-portion 415 to yield an absorption coefficient β_{OH}. The hydroxyl concentration is then derived from the absorption coefficient β_{OH} using the equation:

$$C = {β}_{OH} / ε \times {MW}_{OH} / {D}_{glass} \times 106$$

where C is the concentration of hydroxyl in ppm for a particular segment 420, β_{OH} is the absorption coefficient of the glass, ε is the molar absorptivity of hydroxyl for the absorption peak at a wavenumber of 3670 cm⁻¹, MW_{OH} is the molecular weight of hydroxyl (g/mol), and D_{glass} is the density of hydroxyl (g/cm³). The above-disclosed FTIR analysis is further disclosed in K. M. Davis, et al, “Quantitative infrared spectroscopic measurement of hydroxyl concentration in silica glass,” J. Non-Crystalline Solids, 203 (1996) 27-36, which is incorporated by reference herein. As discussed above, the hydroxyl concentration is measured for each segment 420 of sub-portion 415 and is measured through the full thickness h′ of each segment 420. The hydroxyl concentration measurement is then repeated over all segments 420 of sub-portion 415.

One or more segments 420 may have a different concentration of hydroxyl from one or more other segments 420. However, in embodiments, segments 420 each have substantially the same concentration of hydroxyl regardless of where the segment is located on glass body 400.

Furthermore, an average hydroxyl concentration along the length L′ and width′ of sub-portion 415 may be determined by averaging together the hydroxyl concentrations of the individual segments 420. According to the embodiments disclosed herein, the average hydroxyl concentration of the entirety of sub-portion 415 may be in a range from about 0 ppm to about 2000 ppm, or about 200 ppm to about 1900 ppm, or about 300 ppm to about 1800 ppm, or about 400 ppm to about 1700 ppm, or about 500 ppm to about 1750 ppm, or about 600 ppm to about 1600 ppm, or about 700 ppm to about 1500 ppm, or about 800 ppm to about 1400 ppm, or about 900 ppm to about 1300 ppm, or about 1000 ppm to about 1200 ppm, or about 1000 ppm to about 1100 ppm, or about 600 ppm to about 1500 ppm, or about 600 ppm to about 1400 ppm, or about 600 ppm to about 1300 ppm, or about 700 ppm to about 1000 ppm, or about 50 ppm to about 200 ppm, or about 75 ppm to about 150 ppm, or about 80 ppm to about 125 ppm. In some embodiments, the average hydroxyl concentration of the entirety of sub-portion 415 is about 400 ppm or less, or about 350 ppm or less, or about 300 ppm or less, or about 250 ppm or less, or about 200 ppm or less, or about 150 ppm or less, or about 100 ppm or less, or about 90 ppm or less, or about 80 ppm or less, or about 75 ppm or less, or about 70 ppm or less, or about 60 ppm or less, or about 50 ppm or less. In embodiments, the properties, characteristics, and/or compositional features of glass body 400 may include the average hydroxyl concentration across sub-portion 415.

In some particular embodiments, the maximum hydroxyl concentration among segments 420 may be in a range from about 1000 ppm to about 1400 ppm, or from about 1000 ppm to about 1300 ppm, or from about 1000 ppm to about 1200 ppm, or from about 1000 ppm to about 1100 ppm, or from about 1050 ppm to about 1100 ppm, or from about 1060 ppm to about 1090 ppm. The minimum hydroxyl concentration among segments 420, in some particular embodiments, may be in a range from about 600 ppm to about 1300 ppm, or from about 800 ppm to about 1200 ppm, or from about 900 ppm to about 1100 ppm, or from about 1000 ppm to about 1100 ppm, or from about 1050 ppm to about 1100 ppm, or from about 1060 ppm to about 1080 ppm, or from about 100 ppm to about 500 ppm, or from about 200 ppm to about 400 ppm. In embodiments, the properties, characteristics, and/or compositional features of glass body 400 may include the maximum hydroxyl concentration among segments 420.

It is noted that the hydroxyl concentration of segments 420 may be dependent on whether the above-disclosed consolidation process includes a steam doping process or not. As discussed above, such a steam doping process produces a glass body with a higher concentration of hydroxyl.

The difference between the highest average concentration and the lowest average concentration of hydroxyl among the different segments 420 can also be determined. More specifically, the segment 420 with the highest hydroxyl concentration is compared with the segment 420 with the lowest hydroxyl concentration. Then, the difference between the highest and lowest hydroxyl concentrations is calculated. This difference between the highest concentration and the lowest concentration in a sub-portion 415 is referred to as the peak-to-valley (P-V) difference in concentration. The lower the P-V difference, the more uniform the concentration is in a particular sub-portion. In embodiments, the properties, characteristics, and/or compositional features of glass body 400 may include the P-V hydroxyl concentration.

The P-V difference of hydroxyl concentration of segments 420 in sub-portion 415 may be about 70 ppm or less, or about 60 ppm or less, or about 55 ppm or less, or about 50 ppm or less, or about 45 ppm or less, or about 40 ppm or less, or about 35 ppm or less, or about 30 ppm or less, or about 25 ppm or less, or about 20 ppm or less, or about 15 ppm or less, or about 10 ppm or less, or about 5.0 ppm or less, or about 2.5 ppm or less, or about 1.0 ppm or less, or about 0.0 ppm. Additionally or alternatively, the P-V difference of hydroxyl concentration of segments 420 may be about 0.0 ppm or greater, or about 1.0 ppm or greater, or about 2.5 ppm or greater, or about 5.0 ppm or greater, or about 10 ppm or greater, or about 15 ppm or greater, or about 20 ppm or greater, or about 25 ppm or greater, or about 30 ppm or greater, or about 35 ppm or greater, or about 40 ppm or greater, or about 45 ppm or greater, or about 50 ppm or greater. In some embodiments, the P-V difference of average hydroxyl concentration of segments 420 is within a range of about 0.0 ppm to about 60 ppm, or about 10 ppm to about 50 ppm, or about 15 ppm to about 45 ppm, or about 20 ppm to about 40 ppm, or about 10 ppm to about 30 ppm.

As discussed above, the P-V difference of hydroxyl concentration amongst segments 420 is very low, in embodiments, thus providing a homogenous and uniform glass body 400. Due to such low P-V differences, glass body 400 will maintain its figure in an EUV system. It is noted that the embodiments of the present disclose comprise the above-disclosed P-V ranges at varying maximum and average hydroxyl concentrations. Therefore, for example, the above-disclosed P-V ranges may be in embodiments with relatively high hydroxyl concentrations and in embodiments with relatively low hydroxyl concentrations.

FIG. 4E shows an exemplary concentration plot of a sub-portion 415 divided into segments 420 showing the hydroxyl concentration (in ppm) of each segment 420. Thus, the concentration plot of FIG. 4E shows the segments 420 with the maximum and minimum hydroxyl concentrations and where they are located on sub-portion 415. In embodiments, the properties, characteristics, and/or compositional features of glass body 400 may include a concentration plot of a sub-portion 415 divided into segments 420 and showing a component concentration of one or more segments 420 (such as a hydroxyl concentration of segments 420).

In embodiments, the properties, characteristics, and/or compositional features of glass body 400 may include a P-V titania concentration. The P-V difference of titania concentration of segments 420 in sub-portion 415 may be about 0.0100 wt. % or less, or about 0.0090 wt. % or less, or about 0.0080 wt. % or less, or about 0.0070 wt. % or less, or about 0.0060 wt. % or less, or about 0050 wt. % or less, or about 0.0040 wt. % or less, or about 0.0035 wt. % or less, or about 0.0030 wt. % or less, or about 0.0025 wt. % or less, or about 0.0020 wt. % or less, or about 0.0015 wt. % or less, or about 0.0010 wt. % or less. In embodiments, the P-V difference of titania concentration of segments 420 is in range from about 0.0010 wt. % to about 0.0050 wt. %, or about 0.0015 wt. % to about 0.0045 wt. %, or about 0.0020 wt. % to about 0.0040 wt. %, or about 0.0025 wt. % to about 0.0035 wt. %, or about 0.0030 wt. % to about 0.0050 wt. %, or about 0.0010 wt. % to about 0.0030 wt. %, or about 0.0010 wt. % to about 0.0025 wt. %, or about 0.0010 wt. % to about 0.0020 wt. %.

The P-V difference of titania concentration in glass body 400 may be very low, thus providing a homogenous glass body 400 with not only a uniform concentration of hydroxyl but also of titania.

The concentration of titania of each segment 420 is calculated based upon the measured refractive index of each segment 420. As in well-known in the art, the concentration of titania in a glass body correlates to the refractive index of the glass body. Therefore, for purposes of the present disclosure, refractive index is measured in order to determine the titania concentration of the glass bodies disclosed herein. More specifically, an optical interferometer operating at a wavelength of 633 nm is used to measure the refractive index. In particular, the optical interferometer is a Zygo Verifire HD from Zygo Corporation with a 270 micron pixel size resolution and operating at a wavelength of 633 nm. The optical interferometer is set so that the pixels are square with a size of 270 microns×270 microns, and each pixel extends through the full thickness h′ of sub-portion 415. The refractive index is measured at each pixel within a segment 420 and through the full thickness of the pixel. The refractive indexes, which were each measured for each pixel within a segment 420, are then averaged together to determine the average refractive index of each segment 420. The refractive index measurement is then repeated over all segments 420 of sub-portion 415.

In embodiments, the properties, characteristics, and/or compositional features of glass body 400 may include the refractive index of glass body 400 including a P-V of refractive index among segments 420. The P-V difference of average refractive index of segments 420 across sub-portion 415 may be about 1×10⁻⁴ or less, or about 5×10⁻⁵ or less, or about 1×10⁻⁵ or less, or about 5×10⁻⁶ or less, or about 1×10⁻⁶ or less, or about 5×10⁻⁷ or less, or about 1×10⁻⁷ or less, or from about 1×10⁻⁶ to about 1×10⁻⁴, or about 6×10⁻⁶ to about 9×10⁻⁵, or about 10×10⁻⁶ to about 6×10⁻⁵, or about 1×10⁻⁶ to about 1×10⁻⁵, or about 1×10⁻⁵ to about 1×10⁻⁴. The distribution of refractive index within a glass body is an indicator of the titania concentration distribution of that glass body. Therefore, a glass body with a smaller P-V difference in refractive index will also have a smaller P-V difference of titania. A smaller P-V difference of titania allows the glass body to be more uniformly polished.

In embodiments, the properties, characteristics, and/or compositional features of glass body 400 may include an average Tzc of segments 420. The average Tzc of segments 20 across sample 15 may be in a range from about 20° C. to about 60° C., or from about 25° C. to about 55° C., or from about 30° C. to about 50° C., or from about 35° C. to about 45° C., or from about 40° C. to about 45° C., or from about 20° C. to about 45° C., or from about 20° C. to about 40° C., or from about 10° C. to about 50° C.

Furthermore, in embodiments, the properties, characteristics, and/or compositional features of glass body 400 may include a P-V of Tzc among segments 420. The P-V difference of average Tzc in segments 420 across sub-portion 415 may be from about 0.050° C. to about 0.300° C., or from about 0.075° C. to about 0.250° C., or from about 0.080° C. to about 0.200° C., or from about 0.100° C. to about 0.190° C., or from about 0.120° C. to about 0.180° C., or from about 0.140° C. to about 0.160° C., or from about 0.050° C. to about 0.180° C., or from about 0.100° C. to about 0.140° C.

Due to the low P-V difference of average Tzc in segments 40, glass body 400 is able to maintain its surface shape (“figure”) when subject to temperature changes in an EUV lithography system.

In embodiments, the properties, characteristics, and/or compositional features of glass body 400 may include the CTE of segments 420, such as the average CTE among the segments. The average CTE of segments 420 is about −30 ppb/K to about +30 ppb/K at a temperature between 288K and 303K. In some embodiments the average CTE of segments 420 is about −10 ppb/K to about +10 ppb/K at a temperature between 288K and 303K, or about −5 ppb/K to about +5 ppb/K at a temperature between 288K and 303K, or about −2 ppb/K to about +2 ppb/K at a temperature between 288K and 303K.

Furthermore, in embodiments, the properties, characteristics, and/or compositional features of glass body 400 may include a P-V difference of CTE among segments 420. The P-V difference of CTE of segments 420 across sub-portion 415 may be from about 0.30 ppb/K or less, or about 0.25 ppb/K or less, or about 0.20 ppb/K or less, or about 0.15 ppb/K or less, or about 0.12 ppb/K or less, or about 0.10 ppb/K or less, or about 0.05 ppb/K or less at a temperature between 288K and 303K. In the embodiments, the P-V difference of average CTE of segments 420 across sub-portion 415 is in a range from about 0.05 ppb/K to about 0.25 ppb/K, or about 0.07 ppb/K to about 0.20 ppb/K, or about 0.08 ppb/K to about 0.18 ppb/K, or about 0.09 ppb/K to about 0.16 ppb/K, or about 0.10 ppb/K to about 0.15 at a temperature between 288K and 303K.

With reference again to FIG. 5A, glass body 400 may comprise an identifying marker 500 that corresponds to or is associated with the properties, characteristics, and/or compositional features disclosed herein. FIG. 5A shows an embodiment of glass body 400 with a top surface 412, an opposing bottom surface 414, and one or more side surfaces 416. Although FIG. 5A shows identifying marker 500 as on top surface 412 of glass body 400, identifying marker 500 may be positioned on bottom surface 414 and/or the one or more side surfaces 416 of glass body 400. Furthermore, identifying marker 500 may be positioned within a bulk of glass body 400 (rather than on an outer surface of glass body 400).

As shown in in FIG. 5A, identifying marker 500 may be positioned a distance D from an outer edge 418 of glass body 400. Distance D, in embodiments, is about 1.00 cm or less, or about 0.95 cm or less, or about 0.90 cm or less, or about 0.85 cm or less, or about 0.80 cm or less, or about 0.75 cm or less, or about 0.70 cm or less, or about 0.65 cm or less, or about 0.60 cm or less, or about 0.55 cm or less, or about 0.50 cm or less, or about 0.45 cm or less, or about 0.40 cm or less, or about 0.35 cm or less, or about 0.30 cm or less, or about 0.25 cm or less, or about 0.20 cm or less, or about 0.15 cm or less, or about 0.10 cm or less, or about 0.05 cm or less, or about 0.00 cm or less, or any range or combination of ranges of these endpoints.

In embodiments, distance D may be sufficiently small so that identifying marker 500 is positioned outside of a functional area 430 of glass body 400. Functional area 500 may be the portion of glass body 400 that is patterned with a mask pattern in downstream processing steps. In yet some embodiments, identifying marker 500 is positioned in a portion of glass body 400 that comprises outer, peripheral lip 417 (as disclosed with reference to FIG. 4D).

As discussed above, identifying marker 500 may be positioned on one or more surfaces 412, 414, 416 of glass body 400. In yet other embodiments, identifying marker 500 may be positioned within a bulk of glass body 400. FIG. 5B shows an embodiment in which identifying marker 500 is positioned within a bulk of the glass body rather than on an outer surface of the glass body. In particular, in embodiments, identifying marker 500 is within the bulk of the glass such that it is positioned about 500 microns or greater from an outer surface (e.g., surface 412, 414, or 416 of glass body 400). Such may allow the surface of glass body 400 to be polished in a downstream processing step without disturbing or damaging identifying marker 500. In other embodiments, identifying marker 500 is within the bulk of the glass such that it is positioned about 10 microns or greater, or about 20 microns or greater, or about 30 microns or greater, or about 40 microns or greater, or about 50 microns or greater, or about 60 microns or greater, or about 70 microns or greater, or about 80 microns or greater, or about 90 microns or greater, or about 100 microns or greater, or about 150 microns or greater, or about 200 microns or greater, or about 300 microns or greater, or about 400 microns or greater, or about 500 microns or greater, or about 600 microns or greater, or about 700 microns or greater, or about 800 microns or greater, or about 900 microns or greater, or about 1000 microns or greater from the outer surface (e.g., surface 412, 414, or 416 of glass body 400). Additionally or alternatively, identifying marker 500 is within the bulk of the glass such that it is positioned about 1000 microns or less, or about 900 microns or less, or about 800 microns, or less, or about 700 microns or less, or about 600 microns or less, or about 500 microns or less, or about 400 microns or less, or about 300 microns or less, or about 200 microns or less, or about 150 microns, or less, or about 100 microns or less, or about 90 microns or less, or about 80 microns or less, or about 70 microns or less, or about 60 microns or less, or about 50 microns or less, or about 40 microns or less, or about 30 microns or less, or about 20 microns or less, or about 10 microns or less from the outer surface (e.g., surface 412, 414, or 416 of glass body 400).

In some embodiments identifying marker 500 is positioned within a bulk of glass body such that it extends the entirety from top surface 412 to bottom surface 414 or the entirety from a first side surface 416 to a second side surface 416 of glass body 400. When identifying marker extends throughout a bulk of glass body 400 (such as from top surface 412 to bottom surface 414 or from a first side surface 416 to a second side surface 416), it is contemplated in the embodiments herein that identifying marker 500 may first be formed in glass body 400 and then glass body 400 may be sliced into individual slices. Therefore, identifying marker 500 is present in each individual slice. In yet some embodiments, identifying marker 500 may be positioned obliquely within glass body 400. Therefore, for example, identifying marker 500 may extend from top surface 412 to a side surface 416 of glass body 400.

It contemplated, in embodiments, that identifying marker 500 may be formed on glass body 400 or within the bulk of the glass after glass body 400 has been subjected to a polishing process. In yet other embodiments, identifying marker 500 may be formed on glass body 400 or within the bulk of the glass body 400 before glass body 400 has been subjected to a polishing process. Thus, identifying marker 500 may be positioned a sufficient distance within the bulk of glass body 400 such that identifying marker 500 is not removed during the polishing process. In embodiments in which identifying marker 500 is formed before the polishing step, an index matching (or partially matching) fluid may be applied to glass body 400 to, for example, enhance the laser application to form identifying marker 500 on the glass.

Glass body 400 may comprise more than one identifying marker 500. FIG. 5C shows an exemplary embodiment in which glass body 400 comprises a first identifying marker 500′ on top surface 412, a second identifying marker 500″ on side surface 416, and third identifying marker 500″′ within a bulk of the glass body.

As shown in FIG. 6A, identifying marker may comprise an overall length X, width Y, and height Z. In embodiments, the length X and width Y may each be about 0.5 mm or greater, or about 1 mm or greater, or about 2 mm or greater, or about 3 mm or greater, or about 4 mm or greater, or about 5 mm or greater, or about 6 mm or greater, or about 7 mm or greater, or about 8 mm or greater, or about 9 mm or greater, or about 10 mm or greater. Additionally or alternatively, the length X and width Y may each be about 10 mm or less, or about 9 mm or less, or about 8 mm or less, or about 7 mm or less, or about 6 mm or less, or about 5 mm or less, or about 4 mm or less, or about 3 mm or less, or about 2 mm or less, or about 1 mm or less, or about 0.5 mm or less. In some embodiments, the length X and width Y are each in a range from about 0.5 mm to about 10 mm, or about 1 mm to about 9 mm, or about 2 mm to about 8 mm, or about 3 mm to about 7 mm, or about 4 mm to about 6 mm, or about 5 mm to about 6 mm, or about 3 mm to about 8 mm, or any range or combination of ranges encompassing these endpoints. In yet some embodiments, identifying marker 500 is a square such that the length X is equal to (or substantially equal to) the width Y.

The height Z of identifying marker 500 may be about 1 micron or greater, or about 5 microns or greater, or about 10 microns or greater, or about 20 microns or greater, or about 50 microns or greater, or about 100 microns or greater, or about 200 microns or greater, or about 300 microns or greater, or about 400 microns or greater, or about 500 microns or greater, or about 600 microns or greater, or about 700 microns or greater, or about 800 microns or greater, or about 900 microns or greater, or about 1000 microns or greater. Additionally or alternatively, the height Z may be about 1000 microns or less, or about 900 microns or less, or about 800 microns or less, or about 700 microns or less, or about 600 microns or less, or about 500 microns or less, or about 400 microns or less, or about 300 microns or less, or about 200 microns or less, or about 100 microns or less, or about 50 microns or less, or about 20 microns or less, or about 10 microns or less, or about 5 microns or less, or about 1 micron or less. In embodiments, the height Z is in a range from about 1 micron to about 1000 microns, or about 5 microns to about 900 microns, or about 10 microns to about 800 microns, or about 20 microns to about 700 microns, or about 50 microns to about 600 microns, or about 100 microns to about 500 microns, or about 200 microns to about 400 microns, or about 300 microns to about 400 microns, or any range or combination of ranges encompassing these endpoints. In embodiments, the height Z is less than each of the length X and width Y of identifying marker 500.

It is noted that the size of identifying marker 500 (e.g., the size of the length X, width Y, and height Z) may be dependent on a number of pixels within the marker.

Identifying marker 500 may comprise a marking or engraving or etching or stamping formed on and/or in glass body 400 that encodes information. In embodiments, identifying marker 500 may comprise a difference in one or more glass properties from the remainder of the glass body 400 such as, for example, the refractive index of the glass, the titania oxidation state (e.g., Ti3+ or Ti4+ oxidation state) of the glass, and/or the transmission and/or absorption of the glass material. Furthermore, in embodiments, identifying marker 500 may comprise one or more voids and/or microcracks in the glass, which distinguish identifying marker 500 from the reminder of the glass body 400.

In some embodiments, the application of identifying marker 500 does not significantly alter the properties, characteristics, and/or compositional features of the glass. More specifically, in some embodiments, in the area of identifying marker 500 on glass body 400, the glass comprised the same (or substantially the same) of one or more of properties before and after identifying marker 500 was formed on glass body 400. For example, a specific area of glass body 400 was measured for one or more properties both before and after the formation of identifying maker 500 in that area, and the one or more properties were equal (or substantially equal) from before and after the formation of identifying marker 500. In embodiments, in the area of glass body 400 where identifying maker 500 was formed, the average hydroxyl concentration of the glass, the P-V hydroxyl concentration of the glass, the titania concentration of the glass, the P-V titania concentration of the glass, the refractive index of the glass, the Tzc of the glass, the Tzc slope of the glass, the CTE of the glass, the titania oxidation state (e.g., Ti3+ or Ti4+ oxidation state) of the glass, and/or the transmission and/or absorption of the glass varied by about 10% or less, or about 9% or less, or about 8% or less, or about 7% or less, or about 6% or less, or about 5% or less, or about 4% or less, or about 3% or less, or about 2% or less, or about 0.5% or less, or about 0.0% or less from before the formation of identifying marker 500 to after the formation of identifying marker 500 on glass body 400.

Furthermore, identifying marker 500 may comprise the same or substantially the same glass properties from the remainder of glass body 400 such as, for example, the hydroxyl concentration of the glass, the titania concentration of the glass, the refractive index of the glass, the Tzc of the glass, the Tzc slope of the glass, the CTE of the glass, the titania oxidation state (e.g., Ti3+ or Ti4+ oxidation state) of the glass, and/or the transmission and/or absorption of the glass material. In embodiments, in the area of glass body 400 where identifying maker 500 was formed, the average hydroxyl concentration of the glass, the P-V hydroxyl concentration of the glass, the titania concentration of the glass, the P-V titania concentration of the glass, the refractive index of the glass, the Tzc of the glass, the Tzc slope of the glass, the CTE of the glass, the titania oxidation state (e.g., Ti3+ or Ti4+ oxidation state) of the glass, and/or the transmission and/or absorption of the glass varied by about 10% or less, or about 9% or less, or about 8% or less, or about 7% or less, or about 6% or less, or about 5% or less, or about 4% or less, or about 3% or less, or about 2% or less, or about 0.5% or less, or about 0.0% or less from the remainder of glass body 400. Thus, as one example, identifying marker 500 comprises glass with an average hydroxyl concentration that varies by about 10% or less with the average hydroxyl concentration of the remainder of glass body 400.

In some embodiments, identifying marker 500 is comprised of a plurality of pixels, wherein each pixel is a marking or engraving or etching or stamping formed in and/or on glass body 400. The plurality of pixels together constitutes an overall marker that encodes information corresponding to the above-disclosed properties, characteristics, and/or compositional features of glass body 400. For example, the plurality of pixels together may form a barcode, a QR code, a dot code, a data matrix, one or more encrypted features, and/or an object identifier that corresponds to the above-disclosed properties, characteristics, and/or compositional features of glass body 400. The barcode, QR code, dot code, data matrix, encrypted features, and/or object identifier may be readable in the visible and/or near-infrared spectrum, for example.

FIG. 6B shows an exemplary example of an identifying marker 500 as a barcode comprised of a plurality of pixels 510. In the exemplary example of FIG. 6B, each square in the barcode corresponds to a pixel 510, such that the combination of pixels provides the encoding information corresponding to the above-disclosed properties, characteristics, and/or compositional features of glass body 400. Each pixel 510 may comprise the one or more glass properties that differ from the bulk of the glass (e.g., refractive index, titania oxidation state, transmission, and/or absorption). Furthermore, each pixel 510 may comprise the one or more voids and/or microcracks in the glass. As discussed further below, pixels 510 may be made from a laser beam. In embodiments, each pixel 510 corresponds to a single laser spot from the laser beam, while in other embodiments, each pixel 510 may be formed from two or more laser spots.

FIG. 6C shows an exemplary example of an identifying marker 500 as a data matrix comprised of a plurality of pixels 510. In the exemplary example of FIG. 6C, each circle in the data matrix corresponds to a pixel 510, such that the combination of pixels provides the encoding information corresponding to the above-disclosed properties, characteristics, and/or compositional features of glass body 400. As discussed further below, each pixel 510 in the data matrix may be made from a single laser spot of a laser beam, in embodiments.

It is also contemplated, in embodiments, that identifying marker 500 is not visible by the human eye. For example, identifying mark 500 may be of such a small size that it is not visible by the human eye. Additionally or alternatively, the marking or engraving or etching or stamping in and/or glass body 400 that constitutes identifying marker 500 may not be visible by the human eye.

Identifying marker 500 may be made in and/or on glass body 400 using any well-known means such as any well-known printing means, including but not limited to, laser printing and inkjet printing. In some embodiments, identifying marker 500 may be made in and/or on glass body 400 by etching, such as chemical etching, and/or by a mechanical means.

FIG. 7 shows an exemplary marking system 600 to prepare identifying marker 500 on glass body 400. System 600 comprises an input unit 610, a data control unit 620, and a marking unit 630. Input unit 610 serves as a means for a user to input a marking pattern of an identifying marker 500. In embodiments, input unit 610 may receive the marking pattern as data in the form of characters, symbols, graphics, and/or images and may capture and convert such data into digital information. Data control unit 620 may comprise a processing device, such as a CPU, for processing and storing the digital information received from input unit 610. As is known in the art, data control unit 620 may comprise a memory and storage unit for storing such digital information. Furthermore, data control unit 620 may process such digital information into corresponding marking conditions so that marking unit 630 may perform the marking on glass body 400. Thus, data control unit 620 may send instructions to marking unit 630 instructing marking unit 630 on how to perform the marking in order to produce the desired identifying marker 500.

In some embodiments, marking unit 630 is a laser system so that data control unit 620 sends laser conditions to marking unit 630. The laser conditions instruct marking unit 630 to perform specific laser processing conditions on glass body 400 in order to produce the desired identifying marker 500 (such as an identifying marker 500 with a specific barcode configuration). Marking unit 630 may comprise any well-known laser such as, for example, a nanosecond pulsed laser, a picosecond pulsed laser, a femtosecond pulsed laser, a Nd:YAG laser, a fiber laser, an Excimer laser, or a CO₂ laser.

In some embodiments, marking unit 630 may form a pulsed laser beam that is focused into a laser beam focal line, which is positioned onto and/or through glass body 400 to produce identifying marker 500. For example, the laser beam focal line may produce a pixel 510 onto and/or through glass body 400. The laser beam focal line may generate an induced multi-photon absorption on and/or within the glass, thus producing a material modification to produce identifying marker 500. The laser beam focal line may be created by various optics of marking unit 630. For example, the optics may include a conical lens (i.e., an axicon). Additional description of methods for generating and using a laser beam focal line for forming identifying marker 500 is provided in U.S. Patent Application Publication No. 2021/0269357 and in U.S. Pat. No. 9,517,963, the entirety of each of which are incorporated by reference herein.

The laser beam of marking unit 630 may have a wavelength from about 300 nm to about 2000 nm. For example, the laser beam may have a wavelength from about 300 nm to about 2000 nm, from about 500 nm to about 2000 nm, from about 700 nm to about 2000 nm, from about 900 nm to about 2000 nm, from about 1100 nm to about 2000 nm, from about 1300 nm to about 2000 nm, from about 1500 nm to about 2000 nm, from about 1700 nm to about 2000 nm, from about 1900 nm to about 2000 nm, from about 300 nm to about 1800 nm, from about 300 nm to about 1600 nm, from about 300 nm to about 1400 nm, from about 300 nm to about 1200 nm, from about 300 nm to about 1000 nm, from about 300 nm to about 800 nm, from about 300 nm to about 600 nm, from about 300 nm to about 400 nm, or any range or combination of ranges formed from these endpoints.

The pulse duration and intensity of the laser beam of marking unit 630 should be short enough to achieve a multi-photon absorption effect. Ultra-short pulse lasers may be utilized, such as picosecond or femtosecond laser sources. In one or more embodiments, the laser beam may be formed with a picosecond laser. The operation of such a picosecond laser described herein may create a “pulse burst” of sub-pulses. Producing pulse bursts is a type of laser operation where the emission of pulses is not in a uniform and steady stream, but rather in tight clusters of sub-pulses. Each pulse burst contains multiple individual sub-pulses of very short duration. For example, each pulse burst may include at least 2 sub-pulses, at least 3 sub-pulses, at least 4 sub-pulses, or at least 5 sub-pulses of very short duration. That is a pulse burst is a pocket of sub-pulses and the pulse bursts are separated from one another by a longer duration than the separation of individual adjacent pulses within each burst. In one or more embodiments, each sub-pulse may have a duration of up to about 100 picosecond (“psec”). For example, each sub-pulse may have a duration of about 0.1 psec or greater, or about 0.5 psec or greater, or about 1 psec or greater, or about 5 psec or greater, or about 10 psec or greater, or about 15 psec or greater, or about 18 psec or greater, or about 20 psec or greater, or about 22 psec or greater, or about 25 psec or greater, or about 30 psec or greater, or about 50 psec or greater, or about about 75 psec or greater, or about 100 psec or greater, or any value therebetween. For example, each sub-pulse may have a duration within a range from about 0.1 psec to about 100 psec, or about 0.5 psec to about 75 psec, or about 1 psec to about 50 psec, or about 5 psec to about 30 psec, or about 10 psec to about 25 psec, or about 15 psec to about 22 psec, or about 18 psec to about 20 psec. These individual sub-pulses within a single pulse burst are referred to as sub-pulses herein to denote the fact that they occur within a single pulse burst. The energy or intensity of each individual sub-pulse within the pulse burst may not be equal to that of other sub-pulses within the pulse burst, and the intensity distribution of the multiple sub-pulses within a pulse burst often follows an exponential decay in time governed by the laser design.

Each sub-pulse within the pulse burst of the exemplary embodiments described herein is separated in time from the subsequent sub-pulse in the burst by a duration tₚ from about 1 nsec to about 50 nsec (e.g. about 10 to about 50 nsec, or about 10 to about 30 nsec, with the time often governed by the laser cavity design). In yet other embodiments, the duration tₚ is from about 0.5 psec to about 100 psec (. e.g., about 0.5 psec to about 20 psec, or about 1 psec to about 75 psec). For a given laser, the time separation tₚ between each sub-pulses (sub-pulse-to-sub-pulse separation) within a pulse burst is relatively uniform (±10%). For example, in some embodiments, each sub-pulse within a pulse burst may be separated in time from the subsequent sub-pulse by about 20 nsec (50 MHz). For example, for a laser that produces a sub-pulse separation tₚ of about 20 nsec, the sub-pulse-to-sub-pulse separation tₚ within a pulse burst is maintained within about ±10%, or is about ±2 nsec.

Marking unit 630 may produce the laser beams with a repetition rate from about 1 kHz to about 5 MHz, or about 10 kHz to about 1 MHz, or about 50 kHz to about 900 kHz, or about 100 kHz to about 800 kHz, or about 200 kHz to about 700 kHz, or about 300 kHz to about 600 kHz, or about 400 kHz to about 500 kHz, or any combination of ranges that encompass these endpoints.

Furthermore, the laser beams formed by marking unit 630 may have a pulse energy from about 50 nanojoules (“nJ”) to about 10,000 nJ, or about 100 nJ to about 5,000 nJ, or about 500 nJ to about 2,500 nJ, or about 1,000 nJ to about 2,000 nJ, or any combination of ranges that encompass these endpoints. The laser beams may be focused with a lens focusing length from about 1 mm to about 200 mm, or about 5 mm to about 150 mm, or about 10 mm to about 100 mm, or about 25 mm to about 75 mm, or about 50 mm to about 100 mm, or any combination of ranges that encompass these endpoints. It is noted that relatively longer focusing lengths may be achieved when marking unit 630 comprises a galvo scanner laser with an f-theta lens. A laser scanning speed may be in the range from about 0.01 m/s to about 10 m/s, or about 0.05 m/s to about 8 m/s, or about 0.10 m/s to about 6 m/s, or about 0.25 m/s to about 4 m/s, or about 0.50 m/s to about 2 m/s, or about 0.75 m/s to about 1 m/s, or any combination of ranges that encompass these endpoints.

It some embodiments, marking unit 630 may comprise one or more etchants to chemically etch glass body 400 to form identifying marker 500. Exemplary etchants comprise, for example, potassium hydroxide, sodium hydroxide, calcium hydroxide, ammonium bifluoride, hydrofluoric acid, hydrochloric acid, nitric acid, and/or sulfuric acid.

In yet some embodiments, marking unit 630 may form a damage track within glass body 400 using the laser system disclosed above, and marking unit 630 may then contact the formed damage track with one or more etchants to remove a portion of glass within the damage track. Such may form a pixel 510, for example, on and/or within glass body 400.

As discussed above, identifying marker 500 provides encoding information about the various properties, characteristics, and/or compositional features of glass body 400. FIG. 8 depicts a process 700 for a user to access the encoding information of identifying marker 500. In step 710 of process 700, a user may scan and/or read identifying marker 500 using a scanning device. In embodiments, the scanning device may comprise a device configured to identify encrypted features in, for example, a barcode, a QR code, a dot code, a data matrix, one or more encrypted features, and/or an object identifier. The scanning device may be a handheld device or part of a larger assembly.

In step 720 of process 700, the user then obtains the encoded information of identifying marker 500, such as the various properties, characteristics, and/or compositional features of glass body 400. In some embodiments, the user is able to view the encoded information on the scanning device. Thus, the scanning device may scan and/or read identifying marker 500, decode the information, and display the decoded information to the user. In yet other embodiments, the scanning device may be connected to or associated with a display unit that displays the decoded information to the user. In embodiments, the display unit may also decode the information.

In yet some embodiments, a user may only be able to view the decoded information after providing authentication. For user, the user may be prompted to provide a security passcode before having access to the decoded information.

In step 720, a user is able to view, have access to, and/or obtain the decoded information associated with identifying marker 500. For example, a user may be able to view all of the various properties, characteristics, and/or compositional features of glass body 400 associated with identifying marker 500. In yet other embodiments, a user is only able to view a sub-portion of the various properties, characteristics, and/or compositional features. A managing party may manage and control what decoded information the user is able to view and have access to. For example, the managing party may determine that the user is only able to view information about the CTE and hydroxyl concentration of glass body 400 through identifying marker 500. It is also contemplated that the managing party may update or modify the manage and control of the decoded information accessible to the user through identifying marker 500. For example, the managing party may update the control so that the user is now able to view not only the CTE and hydroxyl information of glass body 400 but also the refractive index of glass body 400 through identifying marker 500. The managing party may be a computer, an entity, or a person.

Furthermore, in some embodiments, the user may view, have access to, and/or obtain the decoded information associated with identifying marker 500 through a secure database. For example, in embodiments, identifying marker 500 may contain encoded information about a URL address or a link or a website to the secure database. The scanning device 710 may scan identifying marker 500 and prompt the user with, for example, a URL address or a link to the secure database. The user may then have access to the decoded information associated with identifying marker 500 through the secure database. In yet some embodiments, the managing party may control and manage the secure database.

As discussed above, the identifying markers disclosed herein may be formed in and/or on glass bodies for use in EUV systems. Thus, in embodiments, glass body 400 comprises a photomask or a reflective mirror. In yet other embodiments, glass body 400 may comprise a lightguide for use in augmented reality devices. In some such embodiments, glass body 400 may be produced (step 110 of process 100) from other processes than process 200 of FIG. 2. Therefore, in the embodiments disclosed herein, the process to produce glass body 400 (step 110 of process 100) is not limited to the steps of process 200 of FIG. 2.

For example, in some embodiments, step 110 of process 100 may comprise melting a glass composition in a furnace and casting the glass into a block. The block may then be consolidated into glass body 400, which may be sliced and polished. In some embodiments, these process steps may be used when glass body 400 is a lightguide for use in augmented reality devices. In some such embodiments, identifying marker 500 on glass body 400 may provide encoded information about, for example, the refractive index, field of view, the transmittance, the absorption, the density, the total thickness variation (TTV), the bow, and/or the warp of glass body 400. Additionally or alternatively, identifying marker 500 may provide encoded information about the titania concentration of glass body 400 and the amount of Ti⁴⁺ and/or Ti³⁺ in glass body 400. For example, in some embodiments, glass body 400 may have a refractive index of about 1.8 or higher, or about 1.9 or higher, or about 2.0 or higher, or about 2.1 or higher, or about 2.2 or higher, or about 2.3 or higher, or about 2.4 or higher, or about 2.5 or higher and identifying maker 500 may provided encoded information about such refractive index.

In yet other embodiments, step 110 of process 100 may comprise using system 800 as shown in FIG. 9. It is noted that system 800 is an alternative system to system 300, as described with reference to FIG. 3A. System 800 comprises a source of a silica precursor 820 and a source of a titania precursor 830. A carrier gas 810, such as nitrogen, is introduced at or near the base of the source of the silica precursor 820 and the source of the titania precursor 830 to entrain the vapors of the silica precursor 820 and the titania precursor 830 and to carry the vapors through distribution systems 840 to mixing manifold 850. A stream of inert gas 815 (e.g., nitrogen gas) may also be brought into contact with the vaporous silica and titania precursors to prevent saturation of the vapors. The silica precursor 820 and the titania precursor vapors 830 mix in mixing manifold 850 and pass through conduits 855 to burners 860 mounted in an upper portion of a furnace 870. The burners 860 produce burner flames 865 and the mixture is delivered to a conversion site 875 where it is converted into soot particle droplets 880. The soot particle droplets 880 are deposited in a revolving collection cup 890 and onto an upper surface of a forming silica-titania glass body 885 inside furnace 870 where the soot particle droplets consolidate and are annealed to form glass body 400.

More specifically, as shown in FIG. 9, the soot particle droplets 885 are ejected form burners 860 as they are combusted and oxidized from a fuel/oxygen mixture at burners 860. The soot particle droplets 880 then accumulate in collection cup 890 and are deposited on the growing glass body 885 to form glass body 400.

In embodiments, the soot particle droplets 880 comprise silicon dioxide and titanium dioxide. And the silicon dioxide and titanium dioxide in the particle droplets mix at the atomic level to form Si—O—Ti bonds. Furthermore, the soot particle droplets 880 are spherical in shape with substantially uniform distributions of SiO₂ and TiO₂ within the particles. The size of each soot particle droplet 880 may vary depending on the conditions of burners 860, but in general, soot particle droplets 880 have an average diameter of about 20 nm to about 500 nm, or about 50 nm to about 400 nm, or about 60 nm to about 300 nm, or about 50 nm to about 100 nm.

The silica precursor 820 may comprise, for example, SiCl₄ and/or octamethylcyclotetrasiloxane (OMCTS), and the titania precursor 830 may comprise, for example, TiCl₄ or titanium isopropoxide (TPT) (titanium tetraisopropoxide (TTIP), tetraisopropyltitanate (TIPT)), as also discussed above with reference to system 300.

In embodiments, system 800 may form a glass body 400 for use in, for example, EUV systems. The glass body 400 produced using system 800 may then have an identifying marker 500 formed in and/or the glass body (step 120 of process 100), as discussed herein.

According to a first aspect, a glass body is disclosed that comprises a top surface, an opposing bottom surface, and one or more side surfaces. An identifying marker is on the top surface, the bottom surface, the one or more side surfaces, and/or within a bulk of the glass body, the identifying marker providing encoded information about one or more properties, characteristics, and/or compositional features of the glass body, wherein a composition of the glass body comprises titania and silica. And, a peak-to-valley of hydroxyl concentration among a plurality of segments of the glass body is about 60 ppm or less, the hydroxyl concentration being measured using a Fourier transform infrared spectroscopy in transmission, and the plurality of segments including every adjacent segment across a length and a width of the glass body, the length being about 25 mm or more and the width being about 25 mm or more.

According to a second aspect, the glass body of the first aspect, wherein the one or more properties, characteristics, and/or compositional features of the glass body comprises the peak-to-valley of hydroxyl concentration among the plurality of segments.

According to a third aspect, the glass body of the first or second aspect, wherein the one or more properties, characteristics, and/or compositional features of the glass body comprises at least one of hydroxyl concentration, titania concentration, refractive index, coefficient of thermal expansion, and zero temperature crossing temperature of the glass body.

According to a fourth aspect, the glass body of any one of the first through third aspect, wherein the identifying marker comprises a barcode, a QR code, a dot code, a data matrix, one or more encrypted features, and/or an object identifier.

According to a fifth aspect, the glass body of any one of the first through fourth aspects, wherein an average hydroxyl concentration among the plurality of segments of the glass body is from about 0 ppm to about 300 ppm, and the one or more properties, characteristics, and/or compositional features of the glass body comprises the average hydroxyl concentration among the plurality of segments.

According to a sixth aspect, the glass body of any one of the first through fifth aspects, wherein the peak-to-valley of hydroxyl concentration among the plurality of segments is about 40 ppm or less.

According to a seventh aspect, the glass body of the sixth aspect, wherein the peak-to-valley of hydroxyl concentration among the plurality of segments is about 20 ppm or less.

According to an eighth aspect, the glass body of the seventh aspect, wherein the peak-to-valley of hydroxyl concentration among the plurality of segments is about 10 ppm or less.

According to a ninth aspect, the glass body of any one of the first through eighth aspects, wherein an average titania concentration among the plurality of segments of the glass body is from about 6.0 wt. % to about 8.0 wt. %, and the one or more properties, characteristics, and/or compositional features of the glass body comprises the average titania concentration among the plurality of segments.

According to a tenth aspect, the glass body of the ninth aspect, wherein the average titania concentration among the plurality of segments of the glass body is from about 7.0 wt. % to about 8.0 wt. %.

According to an eleventh aspect, the glass body of any one of the first through tenth aspects, wherein a peak-to-valley of titania concentration among the plurality of segments is from about 0.0010 wt. % to about 0.0050 wt. % and the one or more properties, characteristics, and/or compositional features of the glass body comprises the average peak-to-valley of titania concentration among the plurality of segments.

According to a twelfth aspect, the glass body of any one of the first through eleventh aspects, wherein a peak-to-valley of refractive index among the plurality of segments of the glass body is about 1×10⁻⁵ or less and the one or more properties, characteristics, and/or compositional features of the glass body comprises the peak-to-valley of refractive index among the plurality of segments.

According to a thirteenth aspect, the glass body of any one of the first through twelfth aspects, wherein the glass body comprises a zero temperature crossing temperature of about 20° C. to about 60° C. and the one or more properties, characteristics, and/or compositional features of the glass body comprises the zero temperature crossing temperature of the glass body.

According to a fourteenth aspect, the glass body of any one of the first through thirteenth aspects, wherein the identifying marker is within a bulk of the glass body.

According to a fifteenth aspect, the glass body of the fourteenth aspect, wherein the identifying maker is a distance of about 100 microns or greater from at least one of the top surface, the opposing bottom surface, and the one or more side surfaces.

According to a sixteenth aspect, the glass body of any one of the first through fifteenth aspects, wherein the length is about 50 mm or more and the width is about 50 mm or more.

According to a seventeenth aspect, the glass body of the sixteenth aspect, wherein the length is about 150 mm or more and the width is about 150 mm or more.

According to an eighteenth aspect, the glass body of any one of the first through seventeenth aspects, wherein each segment has a length (L″) and a width (W″) that are each about 12.7 mm.

According to a nineteenth aspect, the glass body of any one of the first through eighteenth aspects, wherein the glass body is a photomask.

According to a twentieth aspect, a glass body that comprises a top surface, an opposing bottom surface, and one or more side surfaces. An identifying marker is on the top surface, the bottom surface, the one or more side surfaces, and/or within a bulk of the glass body, the identifying marker providing encoded information about at least one of refractive index, transmission, absorption, field of view, total thickness variation, bow, and warp of the glass body of the glass body, and wherein a composition of the glass body comprises silica.

According to a twenty-first aspect, the glass body of the twentieth aspect, wherein the glass body is a lightguide.

According to a twenty-second aspect, the glass body of the twentieth or twenty-first aspect, wherein the identifying marker comprises a barcode, a QR code, a dot code, a data matrix, one or more encrypted features, and/or an object identifier.

According to a twenty-third aspect, a method of producing a glass body with an identifying marker, the method comprising producing a glass body comprised of titania and silica, the glass body comprising a top surface, an opposing bottom surface, and one or more side surfaces. The method further comprising forming an identifying marker on the top surface, the bottom surface, the one or more side surfaces, and/or within a bulk of the glass body, the identifying marker providing encoded information about one or more properties, characteristics, and/or compositional features of the glass body, wherein a peak-to-valley of hydroxyl concentration among a plurality of segments of the glass body is about 60 ppm or less, the hydroxyl concentration being measured using a Fourier transform infrared spectroscopy in transmission, and the plurality of segments including every adjacent segment across a length and a width of the glass body, the length being about 25 mm or more and the width being about 25 mm or more.

According to a twenty-fourth aspect, the method of the twenty-third aspect, wherein the one or more properties, characteristics, and/or compositional features of the glass body comprises the peak-to-valley of hydroxyl concentration among the plurality of segments.

According to a twenty-fifth aspect, the method of the twenty-third or twenty-fourth aspects, wherein producing the glass body comprises forming loose soot particles, pressing the loose soot particles into a molded soot body, and consolidating the molded soot body.

According to a twenty-sixth aspect, the method of any one of the twenty-third through twenty-sixth aspects, wherein the molded soot body comprises a density from about 0.50 g/cm³ to about 1.50 g/cm³.

According to a twenty-seventh aspect, the method of the twenty-sixth aspect, wherein density variation in the molded soot body is about 5% or less.

According to a twenty-eight aspect, the method of any one of the twenty-third through twenty-seventh aspects, wherein consolidating the molded soot body comprises heating the molded soot body in a steam-containing atmosphere.

According to a twenty-ninth aspect, the method of the twenty-eighth aspect, wherein the steam-containing atmosphere comprises a partial pressure of steam of about 0.05 atm or greater.

According to a thirtieth aspect, the method of any one of the twenty-third through twenty-ninth aspects, wherein forming the identifying marker on the top surface, the bottom surface, the one or more side surfaces and/or within the bulk of the glass body comprises forming a marking, engraving, etching, or stamping on and/or in the glass body that encodes information.

According to a thirty-first aspect, the method of the thirtieth aspect, further comprising modifying one or more glass properties of glass body to form the identifying marker.

According to a thirty-second aspect, the method of the thirtieth or thirty-first aspect, further comprising forming a plurality of pixels on the top surface, the bottom surface, the one or more side surfaces and/or within the bulk of the glass body to form the identifying marker.

According to a thirty-third aspect, the method of any one of the thirtieth through thirty-second aspects, further comprising irradiating the glass body with a laser system to form the identifying marker.

According to a thirty-fourth aspect, the method of any one of the thirtieth through thirty-third aspects, further comprising contacting the glass body with an etchant to form the identifying marker.

According to a thirty-fifth aspect, the method of any one of the thirtieth through thirty-fourth aspects, wherein the identifying marker comprises a barcode, a QR code, a dot code, a data matrix, one or more encrypted features, and/or an object identifier.

According to a thirty-sixth aspect, a method of controlling access to encoded information of a glass body, the method comprising providing a glass body with an identifying marker, the identifying marker providing encoded information about one or more properties, characteristics, and/or compositional features of the glass body. The method further comprising managing user access to the encoded information, wherein a composition of the glass body comprises titania and silica. And a peak-to-valley of hydroxyl concentration among a plurality of segments of the glass body is about 60 ppm or less, the hydroxyl concentration being measured using a Fourier transform infrared spectroscopy in transmission, and the plurality of segments including every adjacent segment across a length and a width of the glass body, the length being about 25 mm or more and the width being about 25 mm or more.

According to a thirty-seventh aspect, the method of the thirty-sixth aspect, wherein managing user access to the encoded information comprises controlling user access so that the user is able to view only a sub-portion of the properties, characteristics, and/or compositional features of the glass body.

It will be apparent to those skilled in the art that various modifications and variations can be made to embodiments of the present disclosure without departing from the spirit and scope of the disclosure. Thus, it is intended that the present disclosure cover such modifications and variations provided they come within the scope of the appended claims and their equivalents.

What is claimed is:

1. A glass body comprising:
a top surface, an opposing bottom surface, and one or more side surfaces; and
an identifying marker on the top surface, the bottom surface, the one or more side surfaces, and/or within a bulk of the glass body, the identifying marker providing encoded information about one or more properties, characteristics, and/or compositional features of the glass body,
wherein a composition of the glass body comprises titania and silica, and
wherein a peak-to-valley of hydroxyl concentration among a plurality of segments of the glass body is about 60 ppm or less, the hydroxyl concentration being measured using a Fourier transform infrared spectroscopy in transmission, and the plurality of segments including every adjacent segment across a length and a width of the glass body, the length being about 25 mm or more and the width being about 25 mm or more.

2. The glass body of claim 1, wherein the one or more properties, characteristics, and/or compositional features of the glass body comprises the peak-to-valley of hydroxyl concentration among the plurality of segments.

3. The glass body of claim 1, wherein the one or more properties, characteristics, and/or compositional features of the glass body comprises at least one of hydroxyl concentration, titania concentration, refractive index, coefficient of thermal expansion, and zero temperature crossing temperature of the glass body.

4. The glass body of claim 1, wherein the identifying marker comprises a barcode, a QR code, a dot code, a data matrix, one or more encrypted features, and/or an object identifier.

5. The glass body of claim 1, wherein the identifying marker comprises glass with an average hydroxyl concentration that varies by about 10% or less with the average hydroxyl concentration of the remainder of the glass body.

6. The glass body of claim 1, wherein an average hydroxyl concentration among the plurality of segments of the glass body is from about 0 ppm to about 300 ppm, and the one or more properties, characteristics, and/or compositional features of the glass body comprises the average hydroxyl concentration among the plurality of segments.

7. The glass body of claim 1, wherein the peak-to-valley of hydroxyl concentration among the plurality of segments is about 40 ppm or less.

8. The glass body of claim 7, wherein the peak-to-valley of hydroxyl concentration among the plurality of segments is about 20 ppm or less.

9. The glass body of claim 8, wherein the peak-to-valley of hydroxyl concentration among the plurality of segments is about 10 ppm or less.

10. The glass body of claim 1, wherein an average titania concentration among the plurality of segments of the glass body is from about 6.0 wt. % to about 8.0 wt. %, and the one or more properties, characteristics, and/or compositional features of the glass body comprises the average titania concentration among the plurality of segments.

11. The glass body of claim 10, wherein the average titania concentration among the plurality of segments of the glass body is from about 7.0 wt. % to about 8.0 wt. %.

12. The glass body of claim 1, wherein a peak-to-valley of titania concentration among the plurality of segments is from about 0.0010 wt. % to about 0.0050 wt. % and the one or more properties, characteristics, and/or compositional features of the glass body comprises the average peak-to-valley of titania concentration among the plurality of segments.

13. The glass body of claim 1, wherein a peak-to-valley of refractive index among the plurality of segments of the glass body is about 1×10⁻⁵ or less and the one or more properties, characteristics, and/or compositional features of the glass body comprises the peak-to-valley of refractive index among the plurality of segments.

14. The glass body of claim 1, wherein the glass body comprises a zero temperature crossing temperature of about 20° C. to about 60° C. and the one or more properties, characteristics, and/or compositional features of the glass body comprises the zero temperature crossing temperature of the glass body.

15. The glass body of claim 1, wherein the identifying marker is within a bulk of the glass body.

16. The glass body of claim 15, wherein the identifying maker is a distance of about 100 microns or greater from at least one of the top surface, the opposing bottom surface, and the one or more side surfaces.

17. The glass body of claim 1, wherein the length is about 50 mm or more and the width is about 50 mm or more.

18. The glass body of claim 17, wherein the length is about 150 mm or more and the width is about 150 mm or more.

19. The glass body of claim 1, wherein each segment has a length (L″) and a width (W″) that are each about 12.7 mm.

20. The glass body of claim 1, wherein the glass body is a photomask.

21. A glass body comprising:
a top surface, an opposing bottom surface, and one or more side surfaces; and
an identifying marker on the top surface, the bottom surface, the one or more side surfaces, and/or within a bulk of the glass body, the identifying marker providing encoded information about at least one of refractive index, transmission, absorption, field of view, total thickness variation, bow, and warp of the glass body,
wherein a composition of the glass body comprises silica.
